(19) United States
(12) Patent Application Publication
(10) Pub. No.: US 2026/0223130 A1
(43) Pub. Date: Jul. 30, 2026

(54) MULTIPLE-INPUT MULTIPLE-OUTPUT PHYSICAL DOWNLINK CONTROL CHANNEL TRANSMISSION

(71) Applicant: QUALCOMM Incorporated, San Diego, CA (US)

(72) Inventors: Javier RODRIGUEZ FERNANDEZ, San Diego, CA (US); Kazuki TAKEDA, Minato-ku (JP); Kianoush HOSSEINI, San Diego, CA (US)

(21) Appl. No.: 19/036,784

(22) Filed: Jan. 24, 2025

(51) Int. Cl. H04W 72/232

(52) U.S. Cl. CPC H04W 72/232

(57) ABSTRACT

Various aspects of the present disclosure generally relate to wireless communication. Some aspects more specifically relate to enabling multiple-input multiple-output (MIMO) physical downlink control channel (PDCCH) transmissions via single-layer PDCCH transmissions from multiple transmission and reception points (TRPs). In some aspects, downlink control information (DCI) may be transmitted via a set of linked PDCCH candidates using at least two TRPs. For example, a first PDCCH candidate transmitted from a first TRP may be punctured in accordance with puncturing information indicated in a second PDCCH candidate transmitted from a second TRP. In some aspects, the techniques described herein may support a split DCI transmission via the first TRP and the second TRP. For example, a DCI message may include a first portion transmitted via a first PDCCH candidate using the first TRP and a second portion transmitted via a second PDCCH candidate using the second TRP.

### FIELD OF THE DISCLOSURE

Aspects of the present disclosure generally relate to wireless communication and specifically relate to techniques, apparatuses, and methods associated with multiple-input multiple-output physical downlink control channel transmissions.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

In some examples, a user equipment (UE) and a network node may perform MIMO communication. “MIMO” communication may generally refer to transmitting or receiving multiple signals (such as multiple layers or multiple data streams) simultaneously over the same time and/or frequency resources. For example, a network node 110 and/or a UE 120 may communicate using massive MIMO, multi-user MIMO, or single-user MIMO, which may involve rapid switching between beams or cells. In some cases, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming.

### SUMMARY

Some aspects described herein relate to a user equipment (UE) for wireless communication. The UE may include a processing system that includes one or more processors and one or more memories coupled with the one or more processors. The processing system may be configured to cause the UE to receive a configuration for a multiple-input multiple-output (MIMO) physical downlink control channel (PDCCH) transmission indicating a first set of PDCCH candidates associated with a first search space and a second set of PDCCH candidates associated with a second search space. The processing system may be configured to cause the UE to receive, via a first PDCCH candidate of the first set of PDCCH candidates, a first PDCCH transmission indicating puncturing information associated with a second PDCCH candidate of the second set of PDCCH candidates in accordance with the configuration. The processing system may be configured to cause the UE to monitor the second PDCCH candidate for a second PDCCH transmission in accordance with the puncturing information.

Some aspects described herein relate to a method for wireless communication by a UE. The method may include receiving a configuration for a MIMO PDCCH transmission indicating a first set of PDCCH candidates associated with a first search space and a second set of PDCCH candidates associated with a second search space. The method may include receiving, via a first PDCCH candidate of the first set of PDCCH candidates, a first PDCCH transmission indicating puncturing information associated with a second PDCCH candidate of the second set of PDCCH candidates in accordance with the configuration. The method may include monitoring the second PDCCH candidate for a second PDCCH transmission in accordance with the puncturing information.

Some aspects described herein relate to a non-transitory computer-readable medium that stores a set of instructions for wireless communication by a one or more instructions. The set of instructions, when executed by one or more processors of the of a UE, may cause the UE to receive a configuration for a MIMO PDCCH transmission indicating a first set of PDCCH candidates associated with a first search space and a second set of PDCCH candidates associated with a second search space. The set of instructions, when executed by one or more processors of the UE, may cause the UE to receive, via a first PDCCH candidate of the first set of PDCCH candidates, a first PDCCH transmission indicating puncturing information associated with a second PDCCH candidate of the second set of PDCCH candidates in accordance with the configuration. The set of instructions, when executed by one or more processors of the UE, may cause the UE to monitor the second PDCCH candidate for a second PDCCH transmission in accordance with the puncturing information.

Some aspects described herein relate to an apparatus for wireless communication. The apparatus may include means for receiving a configuration for a MIMO PDCCH transmission indicating a first set of PDCCH candidates associated with a first search space and a second set of PDCCH candidates associated with a second search space. The apparatus may include means for receiving, via a first PDCCH candidate of the first set of PDCCH candidates, a first PDCCH transmission indicating puncturing information associated with a second PDCCH candidate of the second set of PDCCH candidates in accordance with the configuration. The apparatus may include means for monitoring the second PDCCH candidate for a second PDCCH transmission in accordance with the puncturing information.

Some aspects described herein relate to a network node for wireless communication. The network node may include a processing system that includes one or more processors and one or more memories coupled with the one or more processors. The processing system may be configured to cause the network node to transmit a configuration for a MIMO PDCCH transmission indicating a first set of PDCCH candidates associated with a first search space and a second set of PDCCH candidates associated with a second search space. The processing system may be configured to cause the network node to transmit, via a first PDCCH candidate of the first set of PDCCH candidates, a first PDCCH transmission indicating puncturing information associated with a second PDCCH candidate of the second set of PDCCH candidates in accordance with the configuration. The processing system may be configured to cause the network node to transmit, via the second PDCCH candidate, a second PDCCH transmission in accordance with the puncturing information.

Some aspects described herein relate to a method for wireless communication by a network node. The method may include transmitting a configuration for a MIMO PDCCH transmission indicating a first set of PDCCH candidates associated with a first search space and a second set of PDCCH candidates associated with a second search space. The method may include transmitting, via a first PDCCH candidate of the first set of PDCCH candidates, a first PDCCH transmission indicating puncturing information associated with a second PDCCH candidate of the second set of PDCCH candidates in accordance with the configuration. The method may include transmitting, via the second PDCCH candidate, a second PDCCH transmission in accordance with the puncturing information.

Some aspects described herein relate to a non-transitory computer-readable medium that stores a set of instructions for wireless communication by a network node. The set of instructions, when executed by one or more processors of the network node, may cause the network node to transmit a configuration for a MIMO PDCCH transmission indicating a first set of PDCCH candidates associated with a first search space and a second set of PDCCH candidates associated with a second search space. The set of instructions, when executed by one or more processors of the network node, may cause the network node to transmit, via a first PDCCH candidate of the first set of PDCCH candidates, a first PDCCH transmission indicating puncturing information associated with a second PDCCH candidate of the second set of PDCCH candidates in accordance with the configuration. The set of instructions, when executed by one or more processors of the network node, may cause the network node to transmit, via the second PDCCH candidate, a second PDCCH transmission in accordance with the puncturing information.

Some aspects described herein relate to an apparatus for wireless communication. The apparatus may include means for transmitting a configuration for a MIMO PDCCH transmission indicating a first set of PDCCH candidates associated with a first search space and a second set of PDCCH candidates associated with a second search space. The apparatus may include means for transmitting, via a first PDCCH candidate of the first set of PDCCH candidates, a first PDCCH transmission indicating puncturing information associated with a second PDCCH candidate of the second set of PDCCH candidates in accordance with the configuration. The apparatus may include means for transmitting, via the second PDCCH candidate, a second PDCCH transmission in accordance with the puncturing information.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIGS. 3A and 3B are diagrams illustrating a first example and a second example of a single-input-single-output system and a multiple-input multiple-output (MIMO) system, respectively, in accordance with the present disclosure.

FIG. 4 is a diagram illustrating an example resource structure for wireless communication, in accordance with the present disclosure.

FIG. 5 is a diagram illustrating an example of transmission and reception point differentiation at a user equipment (UE), in accordance with the present disclosure.

FIGS. 6A and 6B are diagrams illustrating a first example and a second example of a MIMO system, respectively, in accordance with the present disclosure.

FIG. 7 is a diagram illustrating an example associated with MIMO physical downlink control channel (PDCCH) transmissions, in accordance with the present disclosure.

FIG. 8 is a diagram illustrating an example associated with MIMO PDCCH transmissions, in accordance with the present disclosure.

FIG. 9 is a flowchart illustrating an example process performed, for example, at a UE or an apparatus of a UE that supports MIMO PDCCH transmissions, in accordance with the present disclosure.

FIG. 10 is a flowchart illustrating an example process performed, for example, at a network node or an apparatus of a network node that supports MIMO PDCCH transmissions, in accordance with the present disclosure.

FIG. 11 is a diagram of an example apparatus for wireless communication that supports MIMO PDCCH transmissions, in accordance with the present disclosure.

FIG. 12 is a diagram of an example apparatus for wireless communication that supports MIMO PDCCH transmissions, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some wireless communication networks, a user equipment (UE) and a network node may operate in accordance with multiple-input multiple-output (MIMO) techniques, where one or more signals may be transmitted or received (such as via multiple layers or multiple data streams) concurrently over the same time and/or frequency resources. MIMO communications may generally refer to transmitting or receiving multiple signals (such as multiple layers or multiple data streams) simultaneously over the same time and frequency resources. MIMO techniques generally exploit multipath propagation. A network node and/or UE may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming.

For example, the network node may generate one or more beams, and the UE may generate one or more beams. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

In some examples, MIMO techniques may be used for initial access procedures (for example, transmission and/or reception of synchronization signal blocks (SSBs)), uplink data transmissions (for example, via physical uplink shared channels (PUSCHs)), and/or downlink data transmissions (for example, via physical downlink shared channels (PDSCHs)) between the UE and the network node. In some cases, wireless communication networks may experience challenges associated with implementing MIMO techniques for control signaling. For example, transmission of control signaling via a physical downlink control channel (PDCCH) may be designed to support reception by UEs with different capabilities for MIMO transmissions. Additionally, MIMO PDCCH transmissions pose various challenges, such as coexistence with non-MIMO PDCCH configurations and/or UEs that lack support for receiving MIMO PDCCH transmissions. For example, implementing two-layer PDCCH transmissions that effectively and efficiently coexist with single layer PDCCH candidates poses challenges from at least physical layer design and signaling perspectives.

Additionally or alternatively, supporting MIMO transmissions for control signaling may be subject to constraints relating to physical layer design to support efficient transmission via PDCCHs without a large increase in overhead for the network node and receiving UEs, relative to non-MIMO PDCCH transmissions. For example, designs associated with localized control channel element (CCE) mapping may not adequately exploit frequency diversity, and distributed CCE mappings may increase radio frequency impact and involve higher processing (for example, MIMO processing) on a UE relative to localized CCE mappings.

Various aspects relate generally to supporting MIMO PDCCH transmissions. Some aspects more specifically relate to single-layer PDCCH transmissions performed via multiple transmission and reception points (TRPs). In some aspects, a downlink control information (DCI) message may be transmitted via a set of linked PDCCH candidates by at least two TRPs in accordance with MIMO techniques. For example, a first search space set may be configured for a first cell (for example, a scheduling cell), and the first search space set may include a first PDCCH candidate. Additionally, a second search space set may be configured for a second cell (for example, a scheduled cell), and the second search space set may include a second PDCCH candidate. In some aspects, the first PDCCH candidate may be transmitted from a first TRP and may indicate puncturing information (for example, MIMO information) associated with the second PDCCH candidate, and the second PDCCH candidate transmitted from a second TRP may be punctured in accordance with the puncturing information. In some examples, the first PDCCH candidate and the second PDCCH candidate may be configured to support PDCCH repetition. For example, the first PDDCH candidate transmission may include a first DCI message, which may indicate control information and the puncturing information, and the second PDCCH candidate transmission may include a second DCI message, which may indicate the control information (for example, a repetition of the control information from the first DCI message). Accordingly, the UE may monitor the first PDCCH candidate to obtain the puncturing information, and the UE may monitor the second PDCCH candidate in accordance with the puncturing information to receive the control information indicated by the DCI messages. In some aspects, the first PDCCH candidate and the second PDCCH candidate may be associated with a puncturing state (for example, configured via a search space configuration), and the respective puncturing state may indicate whether the first PDCCH candidate or the second PDCCH candidate includes the puncturing information for the other candidate. In some other examples, a search space index may be used to indicate which PDCCH candidate is to indicate the puncturing information.

Additionally or alternatively, some aspects described herein may support a split DCI transmission via the first TRP and the second TRP in accordance with MIMO techniques. For example, a first portion of a DCI message may be transmitted via a first PDCCH candidate from the first TRP, and a second portion of the DCI message may be transmitted via a second PDCCH candidate from the second TRP. In some aspects, a set of CCEs for the first PDCCH candidate may be aligned (for example, in time, in frequency, or both) with a set of CCEs for the second PDCCH candidate. Additionally or alternatively, a starting CCE and/or an ending CCE for each PDCCH candidate may be configured to the UE, or the positions of each PDCCH candidate may be dynamic (for example, UE may perform blind decoding to monitor for each PDCCH candidate).

Particular aspects of the subject matter described in this disclosure can be implemented to realize one or more of the following potential advantages. In some examples, the described techniques can be used to support PDCCH repetition by supporting PDCCH transmissions via multiple TRPs (for example, using multiple search space sets configured by a scheduling cell and a scheduled cell), thereby increasing the reliability of control signaling relative to non-MIMO transmissions. Additionally, techniques for transmission of DCI via multiple TRPs in accordance with MIMO puncturing techniques may support increased transmission efficiency relative to single TRP transmissions due to increasing a quantity of CCEs available for monitoring by the UE, thereby reducing the probability of the UE experiencing blockage and failing to receive DCI. The techniques described herein may additionally or alternatively support reducing an occurrence of retransmissions due to the increased reliability of control signaling. Consequently, the techniques described herein may reduce latency relative to non-MIMO PDCCH implementations, such as for cells experiencing heavier traffic, as the increased efficiency and reliability of control signaling may reduce scheduling time associated with other data transmissions scheduled by the control signaling. Additionally, split DCI techniques as described herein may leverage time and frequency diversity for DCI transmissions, which may improve the reliability of DCI transmissions.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive MIMO, beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

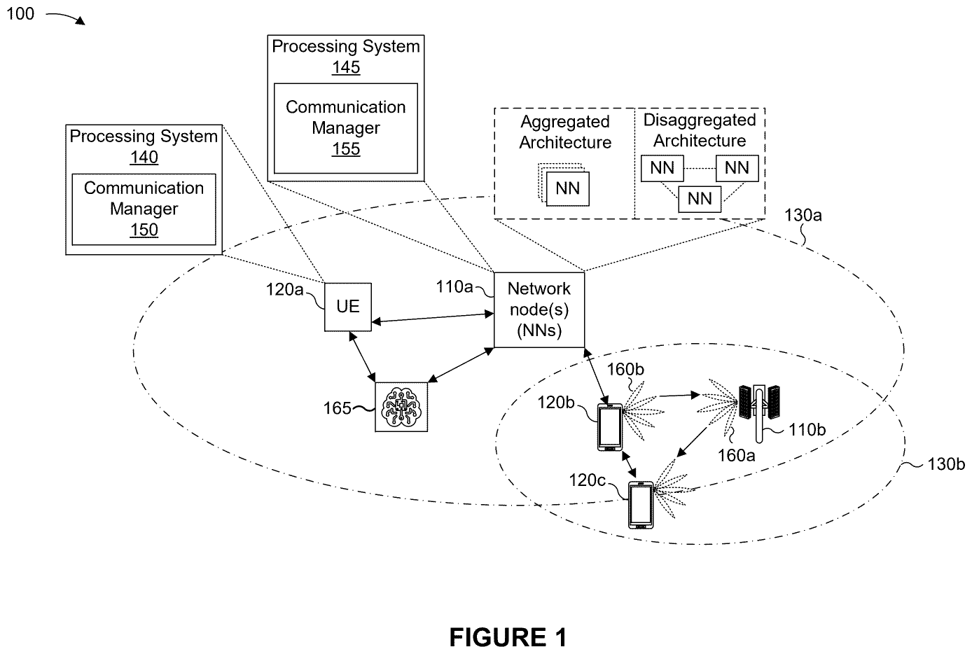

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHZ, FR1 is often referred to (interchangeably) as a “sub-6 GHZ” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHZ,” if used herein, may broadly refer to frequencies that are less than 6 GHZ, that are within FRI, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or include a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a TRP, a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

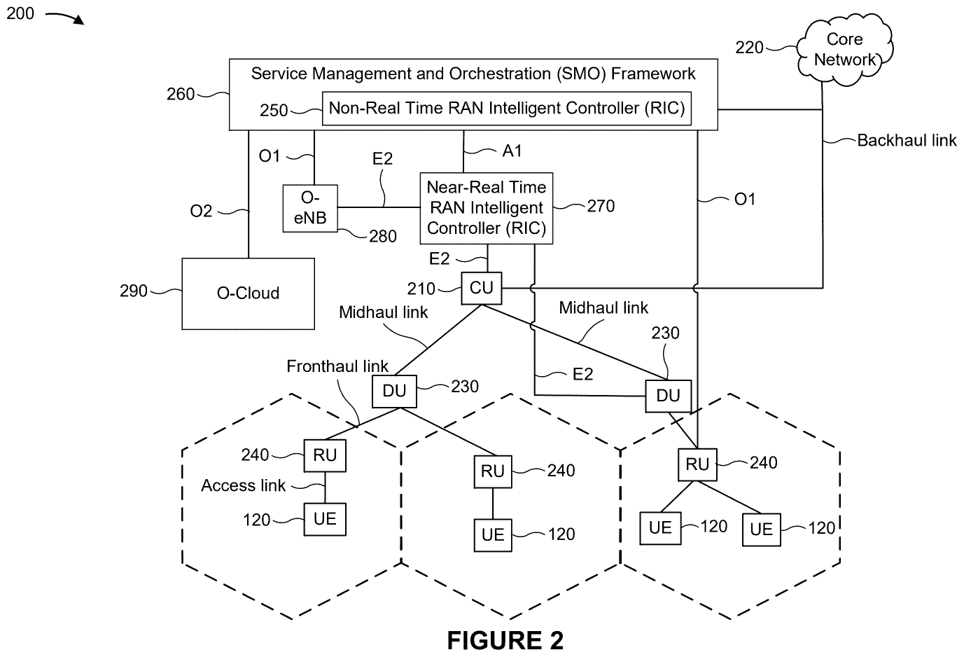

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, in accordance with a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move in accordance with the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified in accordance with different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a DCI configuration to the one or more UEs 120) and/or reconfigured (for example, in real-time or near-real-time) in accordance with changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is configured to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIS), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include PDCCHs, and downlink data channels may include PDSCHs. Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include PUSCHs. Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SS block), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication, as described herein. MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, in accordance with a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples.

In some aspects, the UE 120 may include a communication manager 150. As described in more detail elsewhere herein, the communication manager 150 may receive a configuration for a MIMO PDCCH transmission indicating a first set of PDCCH candidates associated with a first search space and a second set of PDCCH candidates associated with a second search space; receive, via a first PDCCH candidate of the first set of PDCCH candidates, a first PDCCH transmission indicating puncturing information associated with a second PDCCH candidate of the second set of PDCCH candidates in accordance with the configuration; and monitor the second PDCCH candidate for a second PDCCH transmission in accordance with the puncturing information. Additionally or alternatively, the communication manager 150 may perform one or more other operations described herein.

In some aspects, the network node 110 may include a communication manager 155. As described in more detail elsewhere herein, the communication manager 155 may transmit a configuration for a MIMO PDCCH transmission indicating a first set of PDCCH candidates associated with a first search space and a second set of PDCCH candidates associated with a second search space; transmit, via a first PDCCH candidate of the first set of PDCCH candidates, a first PDCCH transmission indicating puncturing information associated with a second PDCCH candidate of the second set of PDCCH candidates in accordance with the configuration; and transmit, via the second PDCCH candidate, a second PDCCH transmission in accordance with the puncturing information. Additionally or alternatively, the communication manager 155 may perform one or more other operations described herein.

FIG. 2 is a diagram illustrating an example disaggregated network node architecture 200 in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUS 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more

PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

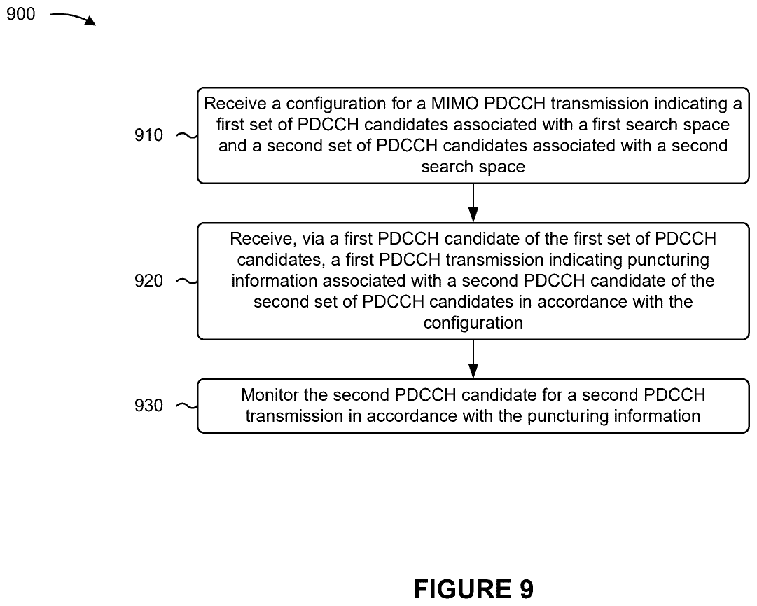

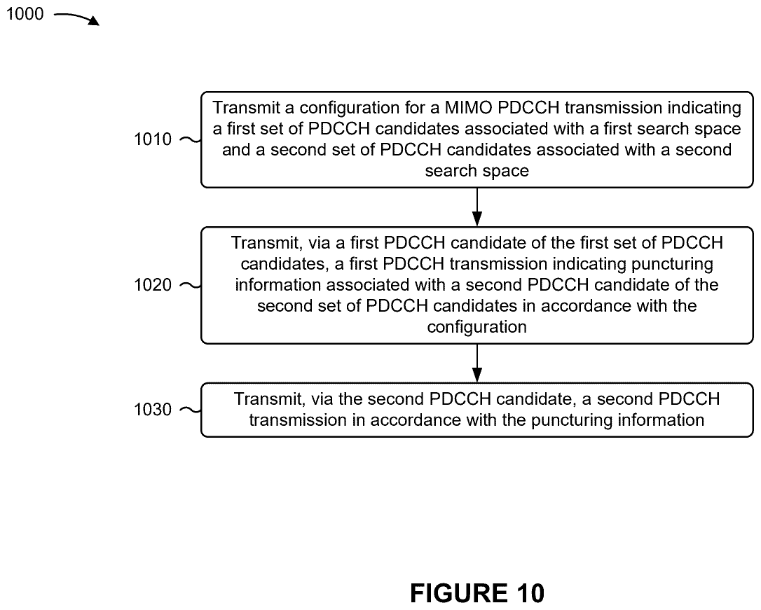

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with MIMO PDCCH transmissions, as described in more detail elsewhere herein. For example, the processing system 145 of the network node 110, the processing system 140 of the UE 120, the CU 210, the DU 230, or the RU 240 may perform or direct operations of, for example, process 900 of FIG. 9, process 1000 of FIG. 10, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 900 of FIG. 9, process 1000 of FIG. 10, or other processes as described herein. In some examples, executing instructions may include running the instructions, converting the instructions, compiling the instructions, and/or interpreting the instructions, among other examples.

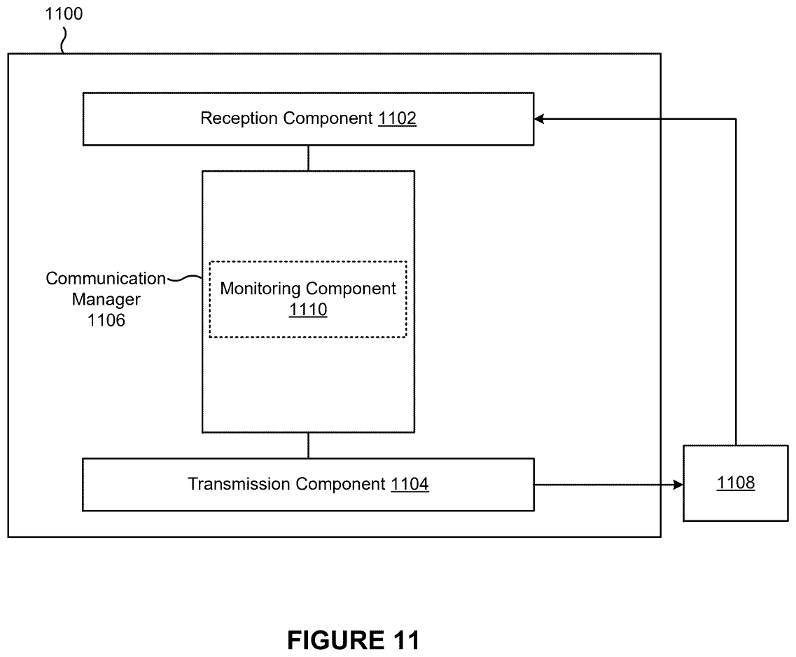

In some aspects, the UE 120 includes means for receiving a configuration for a MIMO PDCCH transmission indicating a first set of PDCCH candidates associated with a first search space and a second set of PDCCH candidates associated with a second search space; means for receiving, via a first PDCCH candidate of the first set of PDCCH candidates, a first PDCCH transmission indicating puncturing information associated with a second PDCCH candidate of the second set of PDCCH candidates in accordance with the configuration; and/or means for monitoring the second PDCCH candidate for a second PDCCH transmission in accordance with the puncturing information. The means for the UE 120 to perform operations described herein may include, for example, one or more of communication manager 150, processing system 140, a radio, one or more RF chains, one or more transceivers, one or more antennas, one or more modems, a reception component (for example, reception component 1102 depicted and described in connection with FIG. 11), and/or a transmission component (for example, transmission component 1104 depicted and described in connection with FIG. 11), among other examples.

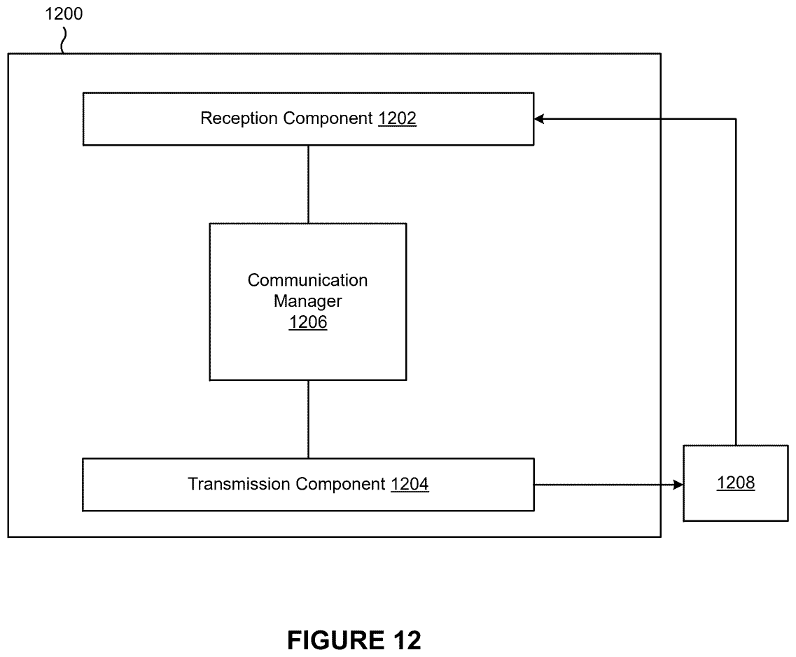

In some aspects, the network node 110 includes means for transmitting a configuration for a MIMO PDCCH transmission indicating a first set of PDCCH candidates associated with a first search space and a second set of PDCCH candidates associated with a second search space; means for transmitting, via a first PDCCH candidate of the first set of PDCCH candidates, a first PDCCH transmission indicating puncturing information associated with a second PDCCH candidate of the second set of PDCCH candidates in accordance with the configuration; and/or means for transmitting, via the second PDCCH candidate, a second PDCCH transmission in accordance with the puncturing information. The means for the network node to perform operations described herein may include, for example, one or more of communication manager 155, processing system 145, a radio, one or more RF chains, one or more transceivers, one or more antennas, one or more modems, a reception component (for example, reception component 1202 depicted and described in connection with FIG. 12), and/or a transmission component (for example, transmission component 1204 depicted and described in connection with FIG. 12), among other examples.

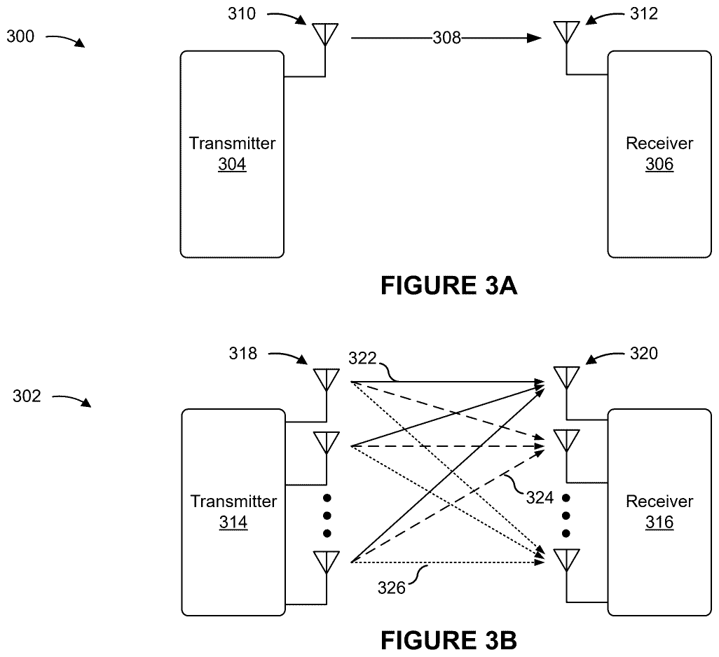

FIGS. 3A and 3B are diagrams illustrating a first example 300 and a second example 302 of a single-input-single-output (SISO) system and a MIMO system, respectively, in accordance with the present disclosure.

SISO systems and MIMO systems are two approaches to wireless communications. The use of a SISO system versus a MIMO system may depend on a variety of operating factors, such as requested data rates, data transfer latency operating conditions, implementation costs, and/or network access demand. A SISO system may provide a cost-effective solution for areas that have low network access demand, while a MIMO system may provide higher data throughput and/or lower data transfer latencies relative to a SISO system.

The first example 300 shown by FIG. 3A is an example SISO system that includes a transmitter device 304 (for example, a network node 110 and/or a UE 120) that wirelessly communicates with a receiver device 306 (for example, a network node 110 and/or a UE 120) based on or otherwise associated with transmitting a wireless signal 308. In the SISO system, the transmitter device 304 includes a first (single) antenna 310 that is used to transmit the wireless signal 308, and the receiver device includes a second (single) antenna 312 to receive the wireless signal 308. In the SISO system, the transmitter device 304 may communicate a single data stream to the receiver device 306 via the wireless signal.

The second example 302 shown by FIG. 3B is an example MIMO system that includes a transmitter device 314 (for example, a network node 110 and/or a UE 120) and a receiver device 316 (for example, a network node 110 and/or a UE 120). In the MIMO system, the transmitter device 314 and the receiver device 316 wirelessly communicate with one another based on or otherwise associated with multiple antennas. To illustrate, the transmitter device 314 may include M antennas as shown by reference number 318, and the receiver device 316 may include N antennas as shown by reference number 320, where M and N are integers that may be equal or different from one another (for example, M=N, M>N, and/or M<N). For clarity, the second example 302 shows a transmitter in communication with a single receiver, but in other examples, the transmitter may serve and/or communicate with multiple receivers using the same antennas.

In some aspects, the transmitter device 314 may transmit multiple data streams via the M antennas based on or otherwise associated with using signal diversity, such as spatial diversity and/or polarization diversity. Typically, the quantity of data streams transmitted by a transmitter device is fewer than a quantity of antennas. That is, the mapping of the quantity of data streams to the quantity of antennas is not 1:1. Rather, each stream may be mapped with a unique set of weighs to all of the available antenna such that all of the available antennas are used to transmit the multiple data streams. To illustrate, the transmitter device 314 may transmit a first data stream 322 (shown with a solid line) using all of the M antenna and a first set of precoding weights. That is, each antenna of the M antenna may transmit a respective signal that carries the first data stream, and the respective signal may be precoded using a particular weight in the first set of precoding weights. Alternatively, or additionally, the transmitter device 314 may transmit a second data stream 324 (shown with a dashed line) using all of the M antenna and a second set of precoding weights and/or a third data stream 326 (shown with a dotted line) using all of the M antenna and a third set of precoding weights. Other examples may include the transmitter device 314 transmitting each data stream using a respective subset of antennas of the M antennas.

“Spatial diversity” may denote spatially diverse signal transmissions. To illustrate, and as described above, the transmitter device 314 may apply precoding to multiple signals that, when summed together, form a first beam at a first carrier frequency, where the first beam propagates in a first direction with a first spatial beamwidth. For example, the precoding may adjust a respective phase and or amplitude of two or more signals that are transmitted by two or more antennas to constructively form the first beam, and the first beam may carry a first data stream. Alternatively, or additionally, the transmitter device 314 may apply precoding to multiple signals that, when summed together, form a second beam at a second carrier frequency (for example, that may be the same carrier frequency as the first carrier frequency or a different carrier frequency from the first carrier frequency) that propagates in a second direction with a second spatial beamwidth. In some aspects, the second beam may carry a second data stream that is different from the first data stream. The transmitter device 314 may select the second propagation direction and/or the second spatial beamwidth to mitigate and/or avoid overlap with the first propagation direction and/or the first spatial beamwidth. That is, the first beam and the second beam may be spatially diverse based on or otherwise associated with propagating in non-overlapping directions with non-overlapping spatial beamwidths (or partially overlapping directions and/or spatial beamwidths).

“Polarization diversity” may denote at least two signals that have diverse polarizations. As one example, an electromagnetic (EM) wave may include an electric field (E-field) and magnetic field (H-field) that propagate along a same propagation line (for example, a same direction) and are perpendicular to one another. For example, in an XYZ coordinate system that is characterized by an X-plane, a Y-plane, and a Z-plane that are perpendicular to one another, the E-field of the EM wave is separated from the H-field by 90 degrees. Accordingly, if an E-field that propagates along an X-axis with an amplitude that varies along the Y-axis (for example, within a horizontal X-Y plane), the H-field may also propagate along the X-axis with an amplitude that varies along the Z-axis (for example, in a perpendicular, vertical X-Z plane). In linear polarization, the E-field and the H-field may propagate without rotating around the propagation line, while in circular polarization, the E-field and the H-field may rotate around the propagation line. In some aspects, the transmitter device 314 may transmit a first signal that is based on or otherwise associated with a first carrier frequency and a first polarization. Alternatively, or additionally, the transmitter device 314 may transmit a second signal that is based on or otherwise associated with a second carrier frequency (for example, that may be the same carrier frequency as the first carrier frequency or a different carrier frequency from the first carrier frequency) and a second polarization that is orthogonal to the first polarization. That is, the first signal and the second signal may have diverse polarizations. For example, the E-field of the first signal is orthogonal to the E-field of the second signal, and the H-field of the first signal is orthogonal to the H-field of the second signal. In some aspects, the first signal may carry first data, and the second signal may carry second data that is different from the first data. To illustrate, the transmitter device 314 may include at least a first antenna that is configured to generate a first signal that has a first polarization and a second antenna that is configured to generate a second signal that has a second polarization.

While the above example describes polarization with respect to orthogonal E-fields and orthogonal H-fields, other examples may use polarizations that are sufficiently decorrelated. For instance, two polarizations may be a complex weighted combination of E-field and H-field polarizations. As another example, the two polarizations may be based on or otherwise associated with a polarization distribution of the antenna elements in an antenna array. With enough decorrelation between polarizations, same of different spatial direction (for example, transmit antenna weights), and same or different frequencies may be used for two transmission paths.

The demand for services provided by a wireless network continues to increase as more and more devices access the wireless network. A MIMO system may, in some cases, meet the demand based on or otherwise associated with the ability to simultaneously and/or contemporaneously transmit multiple data streams. To illustrate, and as described above, the use of multiple antennas in a MIMO system allow a transmitter device to simultaneously and/or contemporaneously transmit the multiple data streams using different paths (for example, different spatial paths and/or different polarization paths), resulting in increased data throughput based on or otherwise associated with transmitting multiple data streams using diverse signals.

In some aspects, the transmitter device 314 and/or receiver device 316 may support single-layer PDCCH transmissions in accordance with MIMO techniques, as described herein. In some examples, DCI may be transmitted via a set of linked PDCCH candidates using at least two TRPs. For example, a first PDCCH candidate including one or more CCEs may be transmitted from a first TRP, and the first PDCCH candidate may indicate puncturing information associated with a second PDCCH candidate linked to the first PDCCH candidate. The second PDCCH candidate may be transmitted from a second TRP, and the second PDCCH candidate may be punctured in accordance with puncturing information (for example, MIMO information) indicated via the first PDCCH candidate. Accordingly, the receiver device 316 may monitor the first PDCCH candidate to obtain the puncturing information, and the receiver device 316 may monitor the second PDCCH candidate in accordance with the puncturing information to receive a DCI message. Additionally or alternatively, the techniques described herein may support a split DCI transmission via the first TRP and the second TRP. For example, a first portion of a DCI message may be transmitted via a first PDCCH candidate using the first TRP, and a second portion of the DCI message may be transmitted via a second PDCCH candidate using the second TRP. Accordingly, by supporting MIMO PDCCH transmissions, the receiver device 316 and/or transmitter device 314 may support increased reliability, throughput, and/or resource efficiency associated with control message transmissions relative to using non-MIMO transmissions.

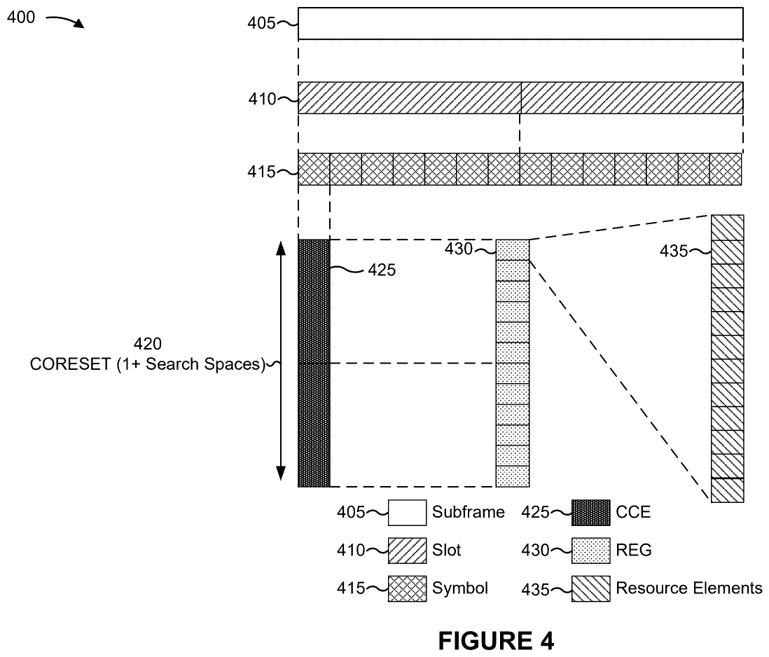

FIG. 4 is a diagram illustrating an example resource structure 400 for wireless communication, in accordance with the present disclosure. Resource structure 400 shows an example of various groups of resources described herein. As shown, resource structure 400 may include a subframe 405. Subframe 405 may include multiple slots 410. While resource structure 400 is shown as including 2 slots per subframe, a different quantity of slots may be included in a subframe (for example, 4 slots, 8 slots, 16 slots, 32 slots, or another quantity of slots). In some aspects, different types of transmission time intervals (TTIs) may be used, other than subframes and/or slots. A slot 410 may include multiple symbols 415, such as 14 symbols per slot.

The potential control region of a slot 410 may be referred to as a control resource set (CORESET) 420 and may be structured to support an efficient use of resources, such as by flexible configuration or reconfiguration of resources of the CORESET 420 for one or more PDCCHs and/or one or more PDSCHs. In some aspects, the CORESET 420 may occupy the first symbol 415 of a slot 410, the first two symbols 415 of a slot 410, or the first three symbols 415 of a slot 410. Thus, a CORESET 420 may include multiple RBs in the frequency domain, and either one, two, or three symbols 415 in the time domain. In 5G, a quantity of resources included in the CORESET 420 may be flexibly configured, such as by using RRC signaling to indicate a frequency domain region (for example, a quantity of resource blocks) and/or a time domain region (for example, a quantity of symbols) for the CORESET 420.

As illustrated, a symbol 415 that includes CORESET 420 may include one or more CCEs 425, shown as two CCEs 425 as an example, that span a portion of the system bandwidth. A CCE 425 may include DCI that is used to transmit control information for wireless communication. A base station may transmit DCI during multiple CCEs 425 (as shown), where the quantity of CCEs 425 used for transmission of DCI represents the aggregation level (AL) used the network node 110 for the transmission of DCI. In FIG. 4, an AL of two is shown as an example, corresponding to two CCEs 425 in a slot 410. In some aspects, different ALs may be used, such as 1, 2, 4, 8, 16, or another AL.

Each CCE 425 may include a fixed quantity of resource element groups (REGs) 430, shown as 6 REGs 430, or may include a variable quantity of REGs 430. In some aspects, the quantity of REGs 430 included in a CCE 425 may be specified by a REG bundle size. A REG 430 may include one RB, which may include 12 resource elements 435 within a symbol 415. A resource element 435 may occupy one subcarrier in the frequency domain and one OFDM symbol in the time domain.

A search space may include all possible locations (for example, in time and/or frequency) where a PDCCH may be located. A CORESET 420 may include one or more search spaces, such as a UE-specific search space, a group-common search space, and/or a common search space. A search space may indicate a set of CCE locations where a UE 120 may find PDCCHs that can potentially be used to transmit control information to the UE. The possible locations for a PDCCH may depend on whether the PDCCH is a UE-specific PDCCH (for example, for a single UE 120) or a group-common PDCCH (for example, for multiple UEs 120) and/or an AL being used. A possible location (for example, in time and/or frequency) for a PDCCH may be referred to as a PDCCH candidate, and the set of all possible PDCCH locations at an AL may be referred to as a search space. For example, the set of all possible PDCCH locations for a particular UE 120 may be referred to as a UE-specific search space. Similarly, the set of all possible PDCCH locations across all UEs 120 may be referred to as a common search space. The set of all possible PDCCH locations for a particular group of UEs 120 may be referred to as a group-common search space. One or more search spaces across ALs may be referred to as a search space (SS) set.

A CORESET 420 may be interleaved or non-interleaved. An interleaved CORESET 420 may have CCE-to-REG mapping such that adjacent CCEs are mapped to scattered REG bundles in the frequency domain (for example, adjacent CCEs are not mapped to consecutive REG bundles of the CORESET 420). A non-interleaved CORESET 420 may have a CCE-to-REG mapping such that all CCEs are mapped to consecutive REG bundles (for example, in the frequency domain) of the CORESET 420.

In some aspects, the resource structure 400 may support single-layer PDCCH transmissions via multiple TRPs in accordance with MIMO techniques. In some examples, DCI may be transmitted via a set of linked PDCCH candidates using at least two TRPs. For example, a first PDCCH candidate including one or more CCEs 425 may be transmitted from a first TRP, and the first PDCCH candidate may indicate puncturing information associated with a second PDCCH candidate linked to the first PDCCH candidate. The second PDCCH candidate may be transmitted from a second TRP, and the second PDCCH candidate may be punctured in accordance with puncturing information (for example, MIMO information) indicated via the first PDCCH candidate. Accordingly, a UE 120 may monitor the first PDCCH candidate to obtain the puncturing information, and the UE 120 may monitor the second PDCCH candidate in accordance with the puncturing information to receive a DCI message. Additionally or alternatively, the techniques described herein may support a split DCI transmission via the first TRP and the second TRP. For example, a first portion of a DCI message may be transmitted via a first PDCCH candidate using the first TRP, and a second portion of the DCI message may be transmitted via a second PDCCH candidate using the second TRP. In some aspects, to support MIMO transmissions of control signaling, a size, quantity of PDCCH candidates, quantity of CCEs, or a combination thereof, associated with a first CORESET 420 corresponding to the first TRP and/or a second CORESET 420 corresponding to the second TRP may be configured to support aligning CCEs 425 for linked PDCCH candidates of the first CORESET 420 and the second CORESET 420 while supporting a PDCCH hashing function. Accordingly, by supporting MIMO PDCCH transmissions, the resource structure 400 may support increased reliability, throughput, and/or resource efficiency associated with control message transmissions relative to using non-MIMO transmissions.

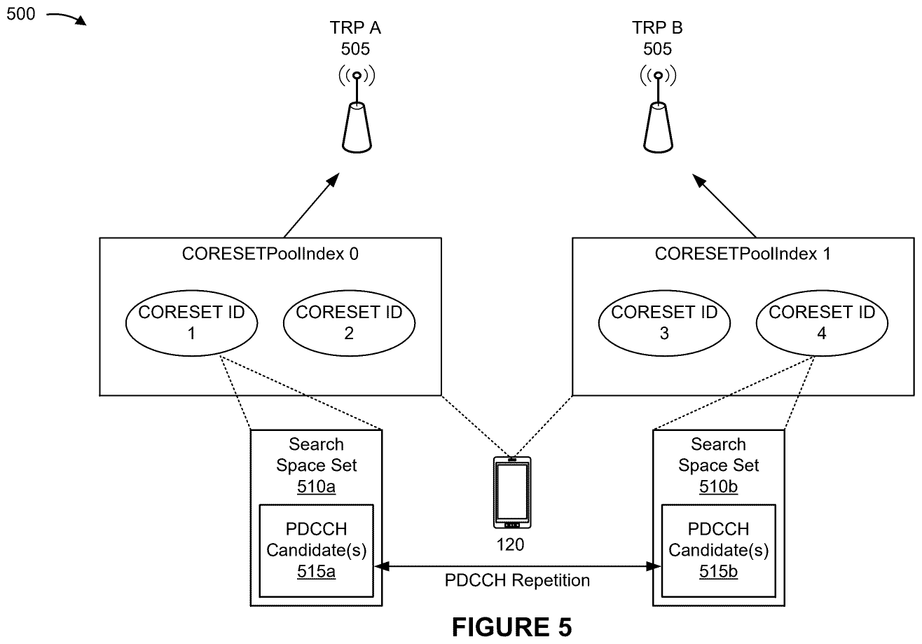

FIG. 5 is a diagram 500 illustrating an example of TRP differentiation at a UE 120 based on or otherwise associated with a CORESET pool index, in accordance with the present disclosure. In some aspects, a CORESET pool index (or CORESETPoolIndex) value may be used by a UE 120 to identify a TRP associated with an uplink grant received on a PDCCH.

A CORESET may refer to a control region that is structured to support an efficient use of resources, such as by flexible configuration or reconfiguration of resources for one or more PDCCHs associated with a UE 120. In some aspects, a CORESET may occupy the first symbol of an orthogonal frequency division multiplexing (OFDM) slot, the first two symbols of an OFDM slot, or the first three symbols of an OFDM slot. Thus, a CORESET may include multiple resource blocks (RBs) in the frequency domain, and either one, two, or three symbols in the time domain. In 5G, a quantity of resources included in a CORESET may be flexibly configured, such as by using RRC signaling to indicate a frequency domain region (for example, a quantity of resource blocks) or a time domain region (for example, a quantity of symbols) for the CORESET.

As illustrated in FIG. 5, a UE 120 may be configured with multiple CORESETs in a given serving cell. Each CORESET configured for the UE 120 may be associated with a CORESET identifier (CORESET ID). For example, a first CORESET configured for the UE 120 may be associated with CORESET ID 1, a second CORESET configured for the UE 120 may be associated with CORESET ID 2, a third CORESET configured for the UE 120 may be associated with CORESET ID 3, and a fourth CORESET configured for the UE 120 may be associated with CORESET ID 4.

As further illustrated in FIG. 5, two or more (for example, up to five) CORESETs may be grouped into a CORESET pool. Each CORESET pool may be associated with a CORESET pool index. As an example, CORESET ID 1 and

CORESET ID 2 may be grouped into CORESET pool index 0, and CORESET ID 3 and CORESET ID 4 may be grouped into CORESET pool index 1. In a multi-TRP configuration, each CORESET pool index value may be associated with a particular TRP 505. As an example, and as illustrated in FIG. 5, a first TRP 505 (TRP A) (or a first network node 110) may be associated with CORESET pool index 0 and a second TRP 505 (TRP B) (or a second network node 110) may be associated with CORESET pool index 1. The UE 120 may be configured by a higher layer parameter, such as PDCCH-Config, with information identifying an association between a TRP and a CORESET pool index value assigned to the TRP. Accordingly, the UE 120 may identify the TRP that transmitted a DCI uplink grant based on or otherwise associated with the CORESET ID of the CORESET in which the PDCCH carrying the DCI uplink grant was transmitted, based on or otherwise associated with the CORESET pool index value associated with the CORESET pool in which the CORESET ID is included, and identifying the TRP associated with the CORESET pool index value.

In some examples, the TRP A and the TRP B may support a multi-TRP PDCCH transmission. For example, one or more network nodes 110 may configure a first CORESET (for example, corresponding to the CORESET ID 1 and a first TCI state) including an SS set 510a and a second CORESET (for example, corresponding to the CORESET ID 4 and a second TCI state) including a SS set 510b. In some cases, the SS set 510a may schedule one or more PDCCH candidates 515a and the SS set 510b may configure one or more PDCCH candidates 515b for monitoring by the UE 120. For example, the one or more PDCCH candidates 515a and the one or more PDCCH candidates 515b may support PDCCH repetition by scheduling repeated DCI messages, which may increase macro diversity (for example, time and/or frequency diversity) for DCI messages. Accordingly, the TRP A and the TRP B may each perform single-layer PDCCH transmissions which may effectively perform as a single two-layer transmission received by the UE 120.

In some aspects, DCI messages may be transmitted via a set of linked PDCCH candidates using at least two TRPs 505. For example, a first PDCCH candidate including one or more CCEs may be transmitted from TRP A, and the first PDCCH candidate may indicate puncturing information associated with a second PDCCH candidate linked to the first PDCCH candidate. The second PDCCH candidate may be transmitted from TRP B, and the second PDCCH candidate may be punctured in accordance with puncturing information (for example, MIMO information) indicated via the first PDCCH candidate. Accordingly, a UE 120 may monitor the first PDCCH candidate to obtain the puncturing information, and the UE 120 may monitor the second PDCCH candidate in accordance with the puncturing information to receive a DCI message. Additionally or alternatively, the techniques described herein may support a split DCI transmission via the first TRP and the second TRP. For example, a first portion of a DCI message may be transmitted via a first PDCCH candidate using the first TRP, and a second portion of the DCI message may be transmitted via a second PDCCH candidate using the second TRP. In some aspects, to support MIMO transmissions of control signaling, a size, quantity of PDCCH candidates, quantity of CCEs, or a combination thereof, associated with a first CORESET corresponding to the TRP A and/or a second CORESET corresponding to the TRP B may be configured to support aligning CCEs for linked PDCCH candidates of the first CORESET and the second CORESET while supporting a PDCCH hashing function. Accordingly, by supporting MIMO PDCCH transmissions, the techniques described with reference to diagram 500 may support increased reliability, throughput, and/or resource efficiency associated with control message transmissions relative to using non-MIMO transmissions.

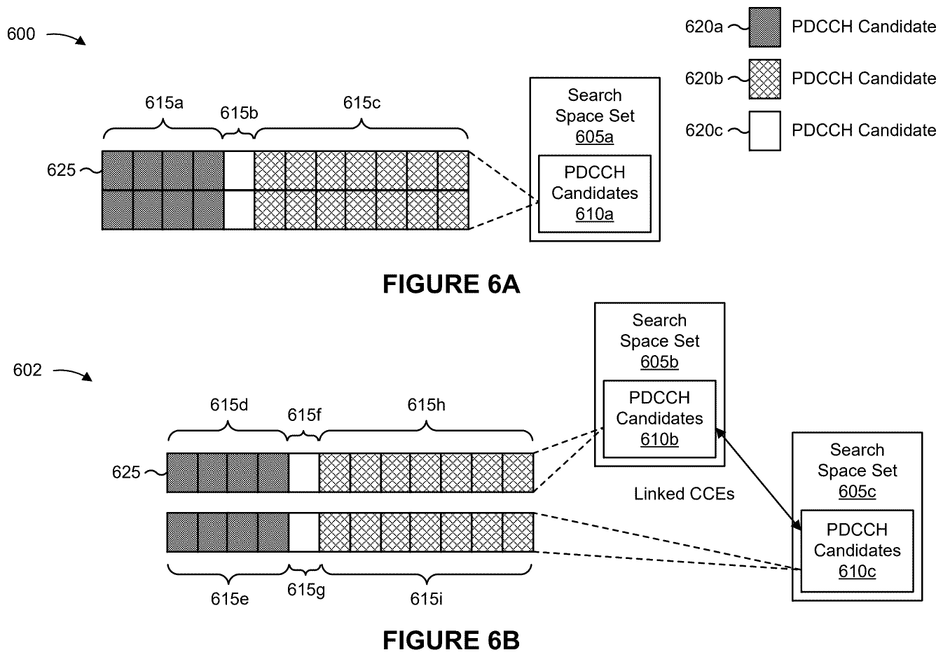

FIGS. 6A and 6B are diagrams illustrating a first example 600 and a second example 602 of a MIMO system, respectively, in accordance with the present disclosure. For example, the example 600 illustrates a first SS set 605a that includes a first set of PDCCH candidates 610a. Similarly, the example 602 illustrate a second SS set 605b that includes a second set of PDCCH candidates 610b and a third SS set 605c that includes a third set of PDCCH candidates 610c. The example 600 and the example 602 may illustrate transmission of a PDCCH candidate 620a, a PDCCH candidate 620b, and a PDCCH candidate 620c. Each PDCCH candidate 620 may include one or more CCEs 625.

The example 600 may illustrate PDCCH transmissions via a single TRP using multiple layers. For example, the first set of PDCCH candidates 610a may include a set of CCEs 615a spanning two layers, which may form the PDCCH candidate 620a. Additionally, the first set of PDCCH candidates 610a may include a set of CCEs 615b spanning the two layers, which may form the PDCCH candidate 620b, and a set of CCEs 615c spanning the two layers, which may form the PDCCH candidate 620c. Accordingly, the example 600 may support transmission of PDCCH candidates 620 via multiple layers, which may improve CORESET efficiency relative to single layer transmissions. However, multi-layer transmissions include additional layer signaling and may increase processing at a receiving device relative to single layer transmissions.

The example 602 may illustrate transmissions via multiple TRPs using a single layer each. For example, two TRPs may transmit a portion of a same PDCCH candidate. In some examples, the second set of PDCCH candidates 610b may include a set of CCEs 615d, which may be used for transmission of at least a portion of the PDCCH candidate 620a. Additionally, the third set of PDCCH candidates 610c may include a set of CCEs 615e, which may be used for transmission of at least a portion of the PDCCH candidate 620a. Similarly, the second set of PDCCH candidates 610b may include a set of CCEs 615f and a set of CCEs 615h that may be used for transmission of at least a portion of the PDCCH candidate 620b and the PDCCH candidate 620c, respectively. Additionally, the third set of PDCCH candidates 610c may include a set of CCEs 615g and a set of CCEs 615i that may be used for transmission of at least a portion of the PDCCH candidate 620b and the PDCCH candidate 620c, respectively.

Accordingly, the example 602 may support multiple single-layer PDCCH transmissions via multiple TRPs, which may improve time and/or frequency diversity relative to single TRP transmissions. Additionally, the example 600 and the example 602 support using a localized CCE mapping (for example, where CCEs 625 are aligned between layers or TRPs), which may reduce MIMO processing and radio frequency impact relative to a distributed CCE mapping. However, the localized CCE mapping may not improve frequency diversity as much as techniques using distributed CCE mapping.

In accordance with aspects as described herein, PDCCH transmissions may be transmitted via a set of linked PDCCH candidates 620 using at least two TRPs. For example, a first PDCCH candidate 620a including one or more CCEs may be transmitted from TRP A, and the first PDCCH candidate 620a may indicate puncturing information associated with a second PDCCH candidate 620b linked to the first PDCCH candidate 620a. The second PDCCH candidate 620b may be transmitted from TRP B, and the second PDCCH candidate 620b may be punctured in accordance with puncturing information (for example, MIMO information) indicated via the first PDCCH candidate 620a. Accordingly, a UE 120 may monitor the first PDCCH candidate 620a to obtain the puncturing information, and the UE 120 may monitor the second PDCCH candidate 620b in accordance with the puncturing information to receive a DCI message. Additionally or alternatively, the techniques described herein may support a split DCI transmission via the first TRP and the second TRP. For example, a first portion of a DCI message may be transmitted via a first PDCCH candidate 620a using the first TRP, and a second portion of the DCI message may be transmitted via a second PDCCH candidate 620b using the second TRP. In some aspects, the techniques described herein may support a using distributed CCE mapping, where CCEs 625 are not aligned between TRP transmissions, which may improve frequency diversity relative to localized CCE mappings.

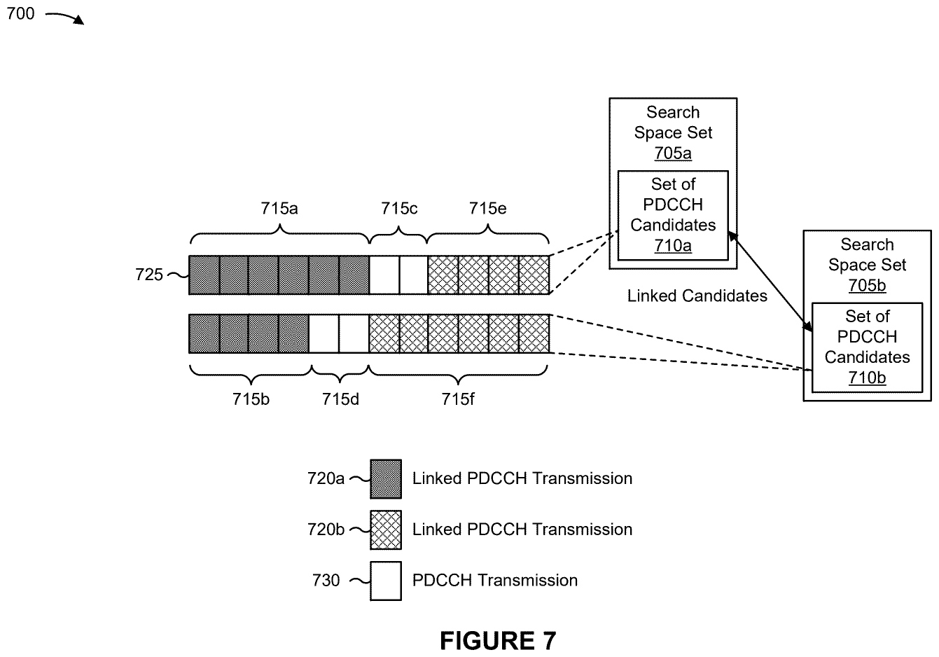

FIG. 7 is a diagram illustrating an example 700 associated with MIMO PDCCH transmissions, in accordance with the present disclosure. For example, the example 700 illustrates a first SS set 705a that includes a first set of PDCCH candidates 710a and a second SS set 705b that includes a second set of PDCCH candidates 710b. In some examples, the first SS set 705a may correspond to a first TRP, and the second SS set 705b may correspond to a second TRP. In some aspects, the first TRP and the second TRP may be associated with one or more network nodes 110.

In some aspects, the first set of PDCCH candidates 710a and the second set of PDCCH candidates 710b may include one or more PDCCH candidates 715 that may be linked for a MIMO PDCCH transmission. For example, the first set of PDCCH candidates 710a may include a PDCCH candidate 715a that may be linked with a PDCCH candidate 715b of the second set of PDCCH candidates 710b for a linked PDCCH transmission 720a. In some examples, each PDCCH candidate 715 may include one or more CCEs 725, as described herein. For example, the PDCCH candidate 715a may include six CCEs 725 (for example, in accordance with an AL of six), and the PDCCH candidate 715b may include four CCEs 725 (for example, in accordance with an AL of four). However, other ALs corresponding to different quantities of CCEs than those shown in the example 700 may be used.

In some examples, the linked PDCCH transmission 720a may include a transmission via the PDCCH candidate 715a, which may be a punctured PDCCH candidate, and a transmission via the PDCCH candidate 715b including puncturing information (for example, MIMO information) for the punctured PDCCH candidate. For example, an RRC message, a DCI message, or another message including the puncturing information may be transmitted via the PDCCH candidate 715b (for example, from the second TRP). The UE 120 may monitor the PDCCH candidate 715b to obtain the puncturing information, and the UE 120 may monitor the PDCCH candidate 715a in accordance with the puncturing information. Accordingly, the techniques described herein may support the linked PDCCH transmission 720a using the PDCCH candidate 715a and the PDCCH candidate 715b, which may be transmitted via the first TRP and the second TRP, respectively, in accordance with MIMO techniques. For example, the PDCCH candidate 715a and the PDCCH candidate 715b may be transmitted using the same time and/or frequency resources via the first TRP and the second TRP, respectively.

In some aspects, to configure MIMO PDCCH transmissions via multiple TRPs, the UE 120 may receive a configuration indicating which SS sets 705 are linked for MIMO PDCCH transmissions. For example, the UE 120 may receive (for example, from a network node 110) a configuration (for example, an RRC configuration) indicating a search space linking identifier (for example, SearchSpaceLinkingId) for each of the first SS set 705a and the second SS set 705b. In some aspects, the search space linking identifier may have a same value for the first SS set 705a and the second SS set 705b to indicate that the first SS set 705a and the second SS set 705b include linked PDCCH candidates. Additionally or alternatively, the configuration may include an indication of a MIMO mode (for example, a further enhanced MIMO mode, or FeMIMO-Mode) corresponding to a puncturing mode, and the puncturing mode may indicate that the first set of PDCCH candidates 710a and the second set of PDCCH candidates 710b are linked candidates for a MIMO PDCCH transmission (for example, using a punctured candidate and a puncturing candidate).

In some aspects, the first SS set 705a and the second SS set 705b may each be associated with a puncturing state, which may be indicated via the configuration. The puncturing state may indicate whether the first SS set 705a or the second SS set 705b include the puncturing candidate (for example, indicating puncturing information) or the punctured candidate. For example, the puncturing state for the first SS set 705a may have a first value (for example, “true”) indicating that the PDCCH candidate 715a is the punctured candidate, and the puncturing state for the second SS set 705b may have a second value (for example, “false”) indicating that the PDCCH candidate 715b is the puncturing candidate that configures (for example, indicates) the puncturing information for the PDCCH candidate 715a. In some other aspects, whether the first SS set 705a or the second SS set 705b include the puncturing candidate or the punctured candidate may be in accordance with an SS index associated with the first SS set 705a and the second SS set 705b. For example, the SS set 705 having the lowest SS index (for example, or the highest index) may configure the puncturing information (for example, via a puncturing candidate), and the other SS set 705 set may include the punctured candidate that is punctured in accordance with the puncturing information.

In some aspects, the PDCCH candidate 715b may indicate a position (for example, in time and/or frequency) of the PDCCH candidate 715a, such as a starting CCE 725 and/or an ending CCE 725. For example, the starting CCE 725 of the PDCCH candidate 715a may be aligned (for example, in frequency and/or time) with the starting CCE 725 of the PDCCH candidate 715b (for example, the starting CCE 725 for the PDCCH candidate 715a may be the same as the starting CCE 725 for the PDCCH candidate 715b). Additionally or alternatively, the ending CCE 725 of the PDCCH candidate 715a may be aligned (for example, in frequency and/or time) with the ending CCE 725 of the PDCCH candidate 715b (for example, the ending CCE 725 for the PDCCH candidate 715a may be the same as the ending CCE 725 for the PDCCH candidate 715b). In some examples, the puncturing information signaled via the PDCCH candidate 715b may indicate whether the starting CCE 725, the ending CCE 725, both, or neither, are aligned for the PDCCH candidate 715a and the PDCCH candidate 715b. Accordingly, the UE 120 may monitor for the PDCCH candidate 715a in accordance with the starting CCE 725 and/or the ending CCE 725 for the PDCCH candidate 715b.

In some aspects, such as when the starting CCE 725 and/or the ending CCE 725 for the PDCCH candidate 715a are not aligned with the PDCCH candidate 715b, the starting CCE 725 and/or the ending CCE 725 for the PDCCH candidate 715a may be indicated by a message (for example, DCI) transmitted via the PDCCH candidate 715b, such as the DCI carrying the puncturing information. Accordingly, the UE 120 may decode the PDCCH candidate 715b (for example, transmitted by the second TRP) indicating the position of the PDCCH candidate 715a, and the UE 120 may monitor for the PDCCH candidate 715a in accordance with decoding the PDCCH candidate 715b indicating the position of the PDCCH candidate 715a. Consequently, by indicating a starting CCE and/or an ending CCE for the PDCCH candidate 715a, an amount of blind decoding performed by the UE 120 to decode the PDCCH candidate 715a may be reduced, thereby decreasing power consumption for the UE 120. In some other examples, the position of the PDCCH candidate 715a may not be indicated via the PDCCH candidate 715b, which may reduce a payload size associated with indicating the position via the PDCCH candidate 715b.

In some cases, the first SS set 705a and the second SS set 705b may be configured such that a hashing function (for example, a PDCCH hashing function) may be compatible with indicating the starting CCE 725 and/or the ending CCE 725 to be aligned for the PDCCH candidate 715a and the PDCCH candidate 715b. For example, a quantity of CCEs 725 for a first CORESET associated with the first SS set 705a and for a second CORESET associated with the second SS set 705b may be a power of two. Additionally or alternatively, a quantity of PDCCH candidates for each of the first SS set 705a and the second SS set 705b may be a power of two. In some examples, when a size of the first CORESET is the same as a size of the second CORESET, a quantity of PDCCH candidates 715 configured for monitoring in the first CORESET may be the same as a quantity of PDCCH candidates 715 configured for monitoring in the second CORESET (for example, such that the starting CCEs 725 are aligned in both CORESETs). In some examples, for the ending CCEs 725 to be aligned for the linked PDCCH candidates 715, the quantity of PDCCH candidates 715 in the CORESET including the linked PDCCH candidate having the smaller AL may be a maximum quantity of PDCCH candidates 715 that may fit within the CORESET.

In some aspects, for the starting CCEs to be aligned for the linked PDCCH candidates 715 when the size of the first CORESET is different form the size of the second CORESET, the larger CORESET may have a quantity of PDCCH candidates configured for monitoring that is in accordance with a size of the smaller CORESET. For example, a first CORESET having a size N₁ greater than a size N₂ of a second CORESET may have a quantity of PDCCH candidates

$${M}_{{N}_{1}} = {M}_{{N}_{2}} \frac{{N}_{1}}{{N}_{2}} ,$$

where M_{N}_{₂} is the quantity of PDCCH candidates for the second CORESET. Accordingly, the larger CORESET may include a larger quantity of PDCCH candidates 715 while matching the starting CCE index in both CORESETs for which such CCE index exists. Additionally, the smaller CORESET may include a smaller quantity of PDCCH candidates 715 while matching the starting CCE index in both CORESETs.

In some cases, the first set of PDCCH candidates 710a and the second set of PDCCH candidates 710b may include one or more PDCCH candidates 715 that are not linked. For example, the first set of PDCCH candidates 710a may include a PDCCH candidate 715c (for example, having AL of two) which may be used for a PDCCH transmission 730 (for example, of DCI using a MIMO or non-MIMO transmission). Similarly, the second set of PDCCH candidates 710b may include a PDCCH candidate 715d (for example, having AL of two) which may be used for a PDCCH transmission 730.

In some examples, the first set of PDCCH candidates 710a and the second set of PDCCH candidates 710b may include multiple linked PDCCH transmissions 720. For example, the first set of PDCCH candidates 710a and the second set of PDCCH candidates 710b may include the linked PDCCH transmission 720a, where the starting CCEs may be aligned for the PDCCH candidate 715a and the PDCCH candidate 715b, and a linked PDCCH transmission 720b, where the ending CCEs may be aligned for a PDCCH candidate 715e and a PDCCH candidate 715f. In some aspects, the PDCCH candidate 715e may be a puncturing candidate used for transmission of puncturing information associated with the PDCCH candidate 715f, which may be a punctured candidate. Accordingly, in some aspects, the first set of PDCCH candidates 710a and the second set of PDCCH candidates 710b may each include puncturing candidates and punctured candidates.

By implementing the techniques described herein, a wireless communication network may support performing linked PDCCH transmissions 720 using MIMO techniques, thereby improving CORESET efficiency and PDCCH reliability by increasing the CCEs 725 available for a UE 120 within a single layer using multiple TRPs.

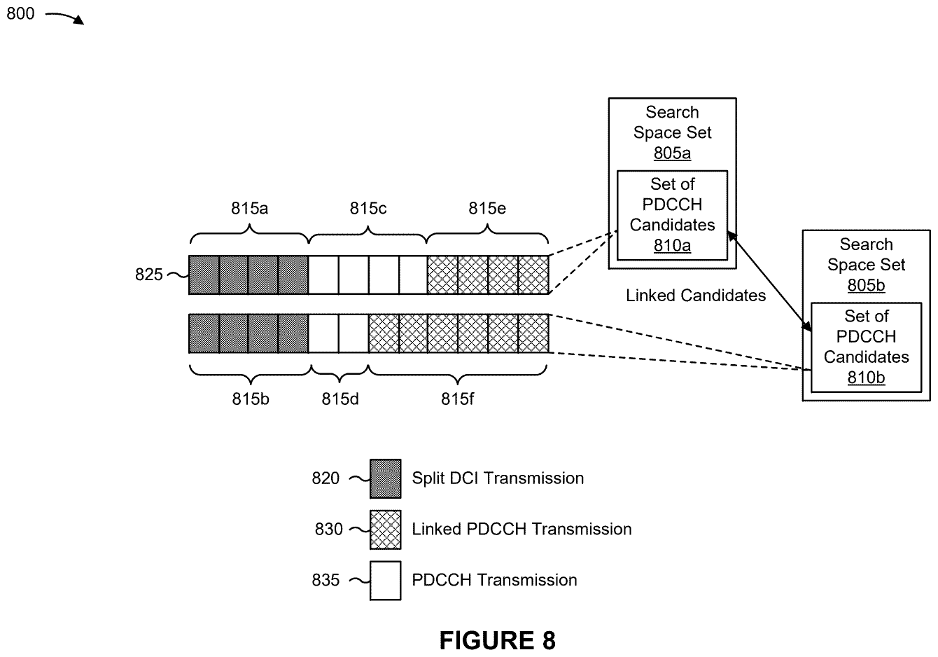

FIG. 8 is a diagram illustrating an example 800 associated with MIMO PDCCH transmissions, in accordance with the present disclosure. For example, the example 800 illustrates an first SS set 805a that includes a first set of PDCCH candidates 810a and an second SS set 805b that includes a second set of PDCCH candidates 810b. In some examples, the first SS set 805a may correspond to a first TRP, and the second SS set 805b may correspond to a second TRP. In some aspects, the first TRP and the second TRP may be associated with one or more network nodes 110.

In some aspects, the first set of PDCCH candidates 810a and the second set of PDCCH candidates 810b may include one or more PDCCH candidates 815 that may be linked for a MIMO PDCCH transmission. For example, the first set of PDCCH candidates 810a may include a PDCCH candidate 815a that may be linked with a PDCCH candidate 815b of the second set of PDCCH candidates 810b for a split DCI transmission 820. In some examples, each PDCCH candidate 815 may include one or more CCEs 825, as described herein. For example, the PDCCH candidate 815a and the PDCCH candidate 815b each may include four CCEs 825 (for example, in accordance with an AL of four).

In some examples, a first portion of the split DCI transmission 820 may be transmitted via the PDCCH candidate 815a (for example, from the first TRP), and a second portion of the split DCI transmission 820 may be transmitted via the PDCCH candidate 815b (for example, from the second TRP). In some examples, a UE 120 may be configured with an indication of a quantity of CCEs 825 and/or a position of the CCEs 825 for the PDCCH candidate 815a and the PDCCH candidate 815b for the split DCI transmission 820. For example, the CCEs 825 for the PDCCH candidate 815a and the PDCCH candidate 815b may be the same (for example, may be aligned in time and/or frequency), and the PDCCH candidate 815a and the PDCCH candidate 815b may have even values for ALs (for example, corresponding to even quantities of CCEs 825). Additionally or alternatively, the UE 120 may receive a message (for example, DCI, or an RRC message, from a network node 110) indicating a starting CCE 825 and/or an ending CCE 825 for the PDCCH candidate 815a and the PDCCH candidate 815b. In some other aspects, the UE 120 does not receive an indication of the positions of the CCEs 825 for the PDCCH candidate 815a and the PDCCH candidate 815b, and the UE 120 may perform blind decoding to decode the split DCI transmission 820.

In some aspects, to configure a split DCI transmission 820 via multiple TRPs, the UE 120 may receive a configuration indicating which SS sets 805 are linked for MIMO split DCI PDCCH transmissions. For example, the UE 120 may receive (for example, from a network node 110) a configuration (for example, an RRC configuration) indicating a search space linking identifier (for example, SearchSpaceLinkingId) for each of the first SS set 805a and the second SS set 805b. In some aspects, the search space linking identifier may have a same value for the first SS set 805a and the second SS set 805b to indicate that the first SS set 805a and the second SS set 805b include linked PDCCH candidates. Additionally or alternatively, the configuration may include a MIMO mode (for example, a further enhanced MIMO mode, or FeMIMO-Mode) indicating a split DCI mode (for example, splitDCI mode) to indicate that the first set of PDCCH candidates 810a and the second set of PDCCH candidates 810b are to transmit a DCI transmission using split DCI techniques.

In some examples, at least one of the PDCCH candidate 815a or the PDCCH candidate 815b may include split DCI configuration information associated with the split DCI transmission 820. For example, the split DCI configuration information May indicate whether the starting and/or ending CCEs are aligned for the PDCCH candidate 815a and the PDCCH candidate 815b, the position of the starting and/or ending CCEs for the PDCCH candidate 815a and the PDCCH candidate 815b, or a combination thereof. In some cases, the PDCCH candidate 815 carrying the split DCI configuration information may be selected in accordance with an indication of which PDCCH candidate 815 is the puncturing candidate, as described herein with reference to FIG. 7. For example, a DCI format may indicate the PDCCH candidate 815 carrying the split DCI configuration information, such as in accordance with a puncturing state (for example, a value of the puncturing state) or an SS index of the SS set 805 corresponding to the PDCCH candidate 815. Additionally or alternatively, the UE 120 may receive a separate message (for example, a DCI message) indicating the split DCI configuration information associated with the split DCI transmission 820. In some cases, the content of the DCI associated with the split DCI transmission 820 may be configured (for example, conditioned) in accordance with the MIMO mode (for example, configured via the RRC configuration). For example, the MIMO mode may indicate the contents of the DCI, or that the DCI is to be transmitted using the split DCI transmission 820.

In some cases, the first set of PDCCH candidates 810a and the second set of PDCCH candidates 810b may include one or more PDCCH candidates 815 that are not used for split DCI transmissions 820. For example, the first set of PDCCH candidates 810a may include a PDCCH candidate 815c (for example, having AL of four) which may be used for a PDCCH transmission 835 (for example, DCI using MIMO or non-MIMO transmission). Similarly, the second set of PDCCH candidates 810b may include a PDCCH candidate 815d (for example, having AL of two) which may be used for a PDCCH transmission 835.

Additionally or alternatively, the first set of PDCCH candidates 810a and the second set of PDCCH candidates 810b may be used for a linked PDCCH transmission 830, as described herein with reference to FIG. 7. For example, the first set of PDCCH candidates 810a may include a PDCCH candidate 815e having four CCEs 825 (for example, in accordance with an AL of four) and the set of PDCCH may include a PDCCH candidate 815f having six CCEs 825 (for example, in accordance with an AL of six), where the PDCCH candidate 815e and the PDCCH candidate 815f are linked for a linked PDCCH transmission. In some aspects, the PDCCH candidate 815e may be a puncturing candidate used for transmission of puncturing information associated with the PDCCH candidate 815f, which may be a punctured candidate, as described herein with reference to FIG. 7.

Accordingly, by implementing the techniques described herein, a wireless communication network may support performing split DCI transmissions 820 using MIMO techniques, thereby improving PDCCH throughput (for example, relative to non-MIMO transmissions) by transmitting a portion of DCI using respective TRPs.

FIG. 9 is a flowchart illustrating an example process 900 performed, for example, at a UE or an apparatus of a UE that supports MIMO PDCCH transmissions in accordance with the present disclosure. Example process 900 is an example where the apparatus or the UE (for example, UE 120) performs operations associated with MIMO PDCCH transmissions.

As shown in FIG. 9, in some aspects, process 900 may include receiving a configuration for a MIMO PDCCH transmission indicating a first set of PDCCH candidates associated with a first search space and a second set of PDCCH candidates associated with a second search space (block 910). For example, the UE (such as by using communication manager 150 or reception component 1102, depicted in FIG. 11) may receive a configuration for a MIMO PDCCH transmission indicating a first set of PDCCH candidates associated with a first search space and a second set of PDCCH candidates associated with a second search space, as described above.

As further shown in FIG. 9, in some aspects, process 900 may include receiving, via a first PDCCH candidate of the first set of PDCCH candidates, a first PDCCH transmission indicating puncturing information associated with a second PDCCH candidate of the second set of PDCCH candidates in accordance with the configuration (block 920). For example, the UE (such as by using communication manager 150 or reception component 1102, depicted in FIG. 11) may receive, via a first PDCCH candidate of the first set of PDCCH candidates, a first PDCCH transmission indicating puncturing information associated with a second PDCCH candidate of the second set of PDCCH candidates in accordance with the configuration, as described above.

As further shown in FIG. 9, in some aspects, process 900 may include monitoring the second PDCCH candidate for a second PDCCH transmission in accordance with the puncturing information (block 930). For example, the UE (such as by using communication manager 150 or monitoring component 1110, depicted in FIG. 11) may monitor the second PDCCH candidate for a second PDCCH transmission in accordance with the puncturing information, as described above.

Process 900 may include additional aspects, such as any single aspect or any combination of aspects described below or in connection with one or more other processes described elsewhere herein.

In a first additional aspect, the first PDCCH candidate is associated with at least one of a starting CCE that is aligned with a starting CCE for the second PDCCH candidate or an ending CCE that is aligned with an ending CCE for the second PDCCH candidate.

In a second additional aspect, alone or in combination with the first aspect, the configuration indicates a first quantity of PDCCH candidates of the first set of PDCCH candidates that is equal to a second quantity of PDCCH candidates of the second set of PDCCH candidates in accordance with a CORESET size associated with the first set of PDCCH candidates being the same as a CORESET size associated with the second set of PDCCH candidates.

In a third additional aspect, alone or in combination with one or more of the first and second aspects, the configuration indicates a size of the first search space that is larger than a size of the second search space and indicates a quantity of PDCCH candidates of the first set of PDCCH candidates that is larger than a quantity of PDCCH candidates of the second set of PDCCH candidates.

In a fourth additional aspect, alone or in combination with one or more of the first through third aspects, the first PDCCH transmission indicates at least one of a starting CCE or an ending CCE for the second PDCCH candidate.

In a fifth additional aspect, alone or in combination with one or more of the first through fourth aspects, the configuration indicates a linking identifier associated with the first search space and the second search space.

In a sixth additional aspect, alone or in combination with one or more of the first through fifth aspects, the configuration indicates a puncturing mode for the first set of PDCCH candidates and the second set of PDCCH candidates.

In a seventh additional aspect, alone or in combination with one or more of the first through sixth aspects, the configuration indicates a puncturing state for the first set of PDCCH candidates, and wherein a value of the puncturing state indicates that the puncturing information associated with the second PDCCH candidate is to be transmitted via the first set of PDCCH candidates.

In an eighth additional aspect, alone or in combination with one or more of the first through seventh aspects, the configuration indicates a first index corresponding to the first search space and a second index corresponding to the second search space, and wherein the first index being lower than the second index indicates that the puncturing information associated with the second PDCCH candidate is to be transmitted via the first set of PDCCH candidates.

In a ninth additional aspect, alone or in combination with one or more of the first through eighth aspects, the first PDCCH transmission includes a first portion of a DCI message and the second PDCCH transmission includes a second portion of the DCI message.

In a tenth additional aspect, alone or in combination with one or more of the first through ninth aspects, a set of CCEs associated with the first set of PDCCH candidates is aligned with a set of CCEs associated with the second set of PDCCH candidates.

In an eleventh additional aspect, alone or in combination with one or more of the first through tenth aspects, an AL associated with the first PDCCH candidate is an even value.

In a twelfth additional aspect, alone or in combination with one or more of the first through eleventh aspects, the configuration indicates one or more of a starting CCE or an ending CCE for each of the first set of PDCCH candidates and the second set of PDCCH candidates.

In a thirteenth additional aspect, alone or in combination with one or more of the first through twelfth aspects, process 900 includes receiving an additional DCI message indicating one or more of a starting CCE or an ending CCE for each of the first PDCCH candidate and the second PDCCH candidate, wherein the additional DCI includes a DCI format associated with configuring a split DCI transmission for the DCI message.

In a fourteenth additional aspect, alone or in combination with one or more of the first through thirteenth aspects, the configuration indicates a split-DCI mode for the first set of PDCCH candidates and the second set of PDCCH candidates.

In a fifteenth additional aspect, alone or in combination with one or more of the first through fourteenth aspects, a quantity of CCEs associated with the first set of PDCCH candidates and a quantity of CCEs associated with the second set of PDCCH candidates are each a power of two.

In a sixteenth additional aspect, alone or in combination with one or more of the first through fifteenth aspects, a quantity of PDCCH candidates associated with the first set of PDCCH candidates and a quantity of PDCCH candidates associated with the second set of PDCCH candidates are each a power of two.

Although FIG. 9 shows example blocks of process 900, in some aspects, process 900 may include additional blocks, fewer blocks, different blocks, or differently arranged blocks than those depicted in FIG. 9. Additionally or alternatively, two or more of the blocks of process 900 may be performed in parallel.

FIG. 10 is a flowchart illustrating an example process 1000 performed, for example, at a network node or an apparatus of a network node that supports MIMO PDCCH transmissions in accordance with the present disclosure. Example process 1000 is an example where the apparatus or the network node (for example, network node 110) performs operations associated with MIMO PDCCH transmissions.

As shown in FIG. 10, in some aspects, process 1000 may include transmitting a configuration for a MIMO PDCCH transmission indicating a first set of PDCCH candidates associated with a first search space and a second set of PDCCH candidates associated with a second search space (block 1010). For example, the network node (such as by using communication manager 155 or transmission component 1204, depicted in FIG. 12) may transmit a configuration for a MIMO PDCCH transmission indicating a first set of PDCCH candidates associated with a first search space and a second set of PDCCH candidates associated with a second search space, as described above.

As further shown in FIG. 10, in some aspects, process 1000 may include transmitting, via a first PDCCH candidate of the first set of PDCCH candidates, a first PDCCH transmission indicating puncturing information associated with a second PDCCH candidate of the second set of PDCCH candidates in accordance with the configuration (block 1020). For example, the network node (such as by using communication manager 155 or transmission component 1204, depicted in FIG. 12) may transmit, via a first PDCCH candidate of the first set of PDCCH candidates, a first PDCCH transmission indicating puncturing information associated with a second PDCCH candidate of the second set of PDCCH candidates in accordance with the configuration, as described above.

As further shown in FIG. 10, in some aspects, process 1000 may include transmitting, via the second PDCCH candidate, a second PDCCH transmission in accordance with the puncturing information (block 1030). For example, the network node (such as by using communication manager 155 or transmission component 1204, depicted in FIG. 12) may transmit, via the second PDCCH candidate, a second PDCCH transmission in accordance with the puncturing information, as described above.

Process 1000 may include additional aspects, such as any single aspect or any combination of aspects described below or in connection with one or more other processes described elsewhere herein.

In a first additional aspect, the first PDCCH candidate is associated with at least one of a starting CCE that is aligned with a starting CCE for the second PDCCH candidate or an ending CCE that is aligned with an ending CCE for the second PDCCH candidate.

In a second additional aspect, alone or in combination with the first aspect, the configuration indicates a first quantity of PDCCH candidates of the first set of PDCCH candidates that is equal to a second quantity of PDCCH candidates of the second set of PDCCH candidates in accordance with a CORESET size associated with the first set of PDCCH candidates being the same as a CORESET size associated with the second set of PDCCH candidates.

In a third additional aspect, alone or in combination with one or more of the first and second aspects, the configuration indicates a size of the first search space that is larger than a size of the second search space, and indicates a quantity of PDCCH candidates of the first set of PDCCH candidates that is larger than a quantity of PDCCH candidates of the second set of PDCCH candidates.

In a fourth additional aspect, alone or in combination with one or more of the first through third aspects, the first PDCCH transmission indicates at least one of a starting CCE or an ending CCE for the second PDCCH candidate.

In a fifth additional aspect, alone or in combination with one or more of the first through fourth aspects, the configuration indicates a linking identifier associated with the first search space and the second search space.

In a sixth additional aspect, alone or in combination with one or more of the first through fifth aspects, the configuration indicates a puncturing mode for the first set of PDCCH candidates and the second set of PDCCH candidates.

In a seventh additional aspect, alone or in combination with one or more of the first through sixth aspects, the configuration indicates a puncturing state for the first set of PDCCH candidates, and wherein a value of the puncturing state indicates that the puncturing information associated with the second PDCCH candidate is to be transmitted via the first set of PDCCH candidates.

In an eighth additional aspect, alone or in combination with one or more of the first through seventh aspects, the configuration indicates a first index corresponding to the first search space and a second index corresponding to the second search space, and wherein the first index being lower than the second index indicates that the puncturing information associated with the second PDCCH candidate is to be transmitted via the first set of PDCCH candidates.

In a ninth additional aspect, alone or in combination with one or more of the first through eighth aspects, the first PDCCH transmission includes a first portion of a DCI message and the second PDCCH transmission includes a second portion of the DCI message.

In a tenth additional aspect, alone or in combination with one or more of the first through ninth aspects, a set of CCEs associated with the first set of PDCCH candidates is aligned with a set of CCEs associated with the second set of PDCCH candidates.

In an eleventh additional aspect, alone or in combination with one or more of the first through tenth aspects, an AL associated with the first PDCCH candidate is an even value.

In a twelfth additional aspect, alone or in combination with one or more of the first through eleventh aspects, the configuration indicates one or more of a starting CCE or an ending CCE for each of the first set of PDCCH candidates and the second set of PDCCH candidates.

In a thirteenth additional aspect, alone or in combination with one or more of the first through twelfth aspects, process 700 includes transmitting an additional DCI message indicating one or more of a starting CCE or an ending CCE for each of the first PDCCH candidate and the second PDCCH candidate, wherein the additional DCI includes a DCI format associated with configuring a split DCI transmission for the DCI message.

In a fourteenth additional aspect, alone or in combination with one or more of the first through thirteenth aspects, the configuration indicates a split-DCI mode for the first set of PDCCH candidates and the second set of PDCCH candidates.

In a fifteenth additional aspect, alone or in combination with one or more of the first through fourteenth aspects, a quantity of CCEs associated with the first set of PDCCH candidates and a quantity of CCEs associated with the second set of PDCCH candidates are each a power of two.

In a sixteenth additional aspect, alone or in combination with one or more of the first through fifteenth aspects, a quantity of PDCCH candidates associated with the first set of PDCCH candidates and a quantity of PDCCH candidates associated with the second set of PDCCH candidates are each a power of two.

Although FIG. 10 shows example blocks of process 1000, in some aspects, process 1000 may include additional blocks, fewer blocks, different blocks, or differently arranged blocks than those depicted in FIG. 10. Additionally or alternatively, two or more of the blocks of process 1000 may be performed in parallel.

FIG. 11 is a diagram of an example apparatus 1100 for wireless communication that supports MIMO PDCCH transmissions in accordance with the present disclosure. The apparatus 1100 may be a UE, or a UE may include the apparatus 1100. In some aspects, the apparatus 1100 includes a reception component 1102, a transmission component 1104, and a communication manager 1106, which may be in communication with one another (for example, via one or more buses). As shown, the apparatus 1100 may communicate with another apparatus 1108 (such as a UE 120, a network node 110, or another wireless communication device) using the reception component 1102 and the transmission component 1104. The communication manager 1106 may be included in, or implemented via, a processing system (for example, the processing system 140). In some aspects, the communication manager 1106 is the communication manager 155

In some aspects, the apparatus 1100 may be configured to and/or operable to perform one or more operations described herein in connection with FIGS. 7-8. Additionally or alternatively, the apparatus 1100 may be configured to and/or operable to perform one or more processes described herein, such as process 900 of FIG. 9.

The reception component 1102 may receive communications, such as reference signals, control information, and/or data communications, from the apparatus 1108. The reception component 1102 may provide received communications to one or more other components of the apparatus 1100, such as the communication manager 1106. In some aspects, the reception component 1102 may perform signal processing on the received communications, and may provide the processed signals to the one or more other components in a similar manner as described above in connection with FIG. 1. In some aspects, the reception component 1102 may include one or more components of the UE described above in connection with FIG. 1, such as a radio, one or more RF chains, one or more transceivers, or one or more modems, each of which may in turn be coupled with one or more antennas of the UE.

The transmission component 1104 may transmit communications, such as reference signals, control information, and/or data communications, to the apparatus 1108. In some aspects, the communication manager 1106 may generate communications and may transmit the generated communications to the transmission component 1104 for transmission to the apparatus 1108. In some aspects, the transmission component 1104 may perform signal processing on the generated communications, and may transmit the processed signals to the apparatus 1108 in a similar manner as described above in connection with FIG. 1. In some aspects, the transmission component 1104 may include one or more components of the UE described above in connection with FIG. 1, such as a radio, one or more RF chains, one or more transceivers, or one or more modems, each of which may in turn be coupled with one or more antennas of the UE. In some aspects, the transmission component 1104 may be co-located with the reception component 1102.

The communication manager 1106 may receive or may cause the reception component 1102 to receive a configuration for a MIMO PDCCH transmission indicating a first set of PDCCH candidates associated with a first search space and a second set of PDCCH candidates associated with a second search space. The communication manager 1106 may receive or may cause the reception component 1102 to receive, via a first PDCCH candidate of the first set of PDCCH candidates, a first PDCCH transmission indicating puncturing information associated with a second PDCCH candidate of the second set of PDCCH candidates in accordance with the configuration. The communication manager 1106 may monitor the second PDCCH candidate for a second PDCCH transmission in accordance with the puncturing information. In some aspects, the communication manager 1106 may perform one or more operations described elsewhere herein as being performed by one or more components of the communication manager 1106.

In some aspects, the communication manager 1106 includes a set of components, such as a monitoring component 1110. Alternatively, the set of components may be separate and distinct from the communication manager 1106. As used herein, the term “component” is intended to be broadly construed as hardware or a combination of hardware and at least one of software or firmware. In some aspects, one or more components of the set of components may include or may be implemented within a processing system (for example, the processing system 140). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The reception component 1102 may receive a configuration for a MIMO PDCCH transmission indicating a first set of PDCCH candidates associated with a first search space and a second set of PDCCH candidates associated with a second search space. The reception component 1102 may receive, via a first PDCCH candidate of the first set of PDCCH candidates, a first PDCCH transmission indicating puncturing information associated with a second PDCCH candidate of the second set of PDCCH candidates in accordance with the configuration. The monitoring component 1110 may monitor the second PDCCH candidate for a second PDCCH transmission in accordance with the puncturing information.

The reception component 1102 may receive an additional DCI message indicating one or more of a starting CCE or an ending CCE for each of the first PDCCH candidate and the second PDCCH candidate, wherein the additional DCI includes a DCI format associated with configuring a split DCI transmission for the DCI message.

The quantity and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally or alternatively, a set of (one or more) components shown in FIG. 11 may perform one or more functions described as being performed by another set of components shown in FIG. 11.

FIG. 12 is a diagram of an example apparatus 1200 for wireless communication that supports MIMO PDCCH transmissions in accordance with the present disclosure. The apparatus 1200 may be a network node, or a network node May include the apparatus 1200. In some aspects, the apparatus 1200 includes a reception component 1202, a transmission component 1204, and a communication manager 1206, which may be in communication with one another (for example, via one or more buses). As shown, the apparatus 1200 may communicate with another apparatus 1208 (such as a UE 120, a network node 110, or another wireless communication device) using the reception component 1202 and the transmission component 1204. The communication manager 1206 may be included in, or implemented via, a processing system (for example, the processing system 145). In some aspects, the communication manager 1206 is the communication manager 155.

In some aspects, the apparatus 1200 may be configured to and/or operable to perform one or more operations described herein in connection with FIGS. 7-8. Additionally or alternatively, the apparatus 1200 may be configured to and/or operable to perform one or more processes described herein, such as process 1000 of FIG. 12.

The reception component 1202 may receive communications, such as reference signals, control information, and/or data communications, from the apparatus 1208. The reception component 1202 may provide received communications to one or more other components of the apparatus 1200, such as the communication manager 1206. In some aspects, the reception component 1202 may perform signal processing on the received communications, and may provide the processed signals to the one or more other components in a similar manner as described above in connection with FIG. 1. In some aspects, the reception component 1202 may include one or more components of the network node described above in connection with FIG. 1, such as a radio, one or more RF chains, one or more transceivers, or one or more modems, each of which may in turn be coupled with one or more antennas of the network node.

The transmission component 1204 may transmit communications, such as reference signals, control information, and/or data communications, to the apparatus 1208. In some aspects, the communication manager 1206 may generate communications and may transmit the generated communications to the transmission component 1204 for transmission to the apparatus 1208. In some aspects, the transmission component 1204 may perform signal processing on the generated communications, and may transmit the processed signals to the apparatus 1208 in a similar manner as described above in connection with FIG. 1. In some aspects, the transmission component 1204 may include one or more components of the network node described above in connection with FIG. 1, such as a radio, one or more RF chains, one or more transceivers, or one or more modems, each of which may in turn be coupled with one or more antennas of the network node. In some aspects, the transmission component 1204 may be co-located with the reception component 1202.

The communication manager 1206 may transmit or may cause the transmission component 1204 to transmit a configuration for a MIMO PDCCH transmission indicating a first set of PDCCH candidates associated with a first search space and a second set of PDCCH candidates associated with a second search space. The communication manager 1206 may transmit or may cause the transmission component 1204 to transmit, via a first PDCCH candidate of the first set of PDCCH candidates, a first PDCCH transmission indicating puncturing information associated with a second PDCCH candidate of the second set of PDCCH candidates in accordance with the configuration. The communication manager 1206 may transmit, via the second PDCCH candidate, a second PDCCH transmission in accordance with the puncturing information. In some aspects, the communication manager 1206 may perform one or more operations described elsewhere herein as being performed by one or more components of the communication manager 1206.

In some aspects, the communication manager 1206 may include a set of components for performing functions as described herein. Alternatively, the set of components may be separate and distinct from the communication manager 1206. As used herein, the term “component” is intended to be broadly construed as hardware or a combination of hardware and at least one of software or firmware. In some aspects, one or more components of the set of components may include or may be implemented within a processing system (for example, the processing system 145). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The transmission component 1204 may transmit a configuration for a MIMO PDCCH transmission indicating a first set of PDCCH candidates associated with a first search space and a second set of PDCCH candidates associated with a second search space. The transmission component 1204 may transmit, via a first PDCCH candidate of the first set of PDCCH candidates, a first PDCCH transmission indicating puncturing information associated with a second PDCCH candidate of the second set of PDCCH candidates in accordance with the configuration. The transmission component 1204 may transmit, via the second PDCCH candidate, a second PDCCH transmission in accordance with the puncturing information.

The transmission component 1204 may transmit an additional DCI message indicating one or more of a starting CCE or an ending CCE for each of the first PDCCH candidate and the second PDCCH candidate, wherein the additional DCI includes a DCI format associated with configuring a split DCI transmission for the DCI message.

The quantity and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally or alternatively, a set of (one or more) components shown in FIG. 12 may perform one or more functions described as being performed by another set of components shown in FIG. 12.

The following provides an overview of some Aspects of the present disclosure:
Aspect 1: A method of wireless communication by a UE, comprising: receiving a configuration for a MIMO PDCCH transmission indicating a first set of PDCCH candidates associated with a first search space and a second set of PDCCH candidates associated with a second search space; receiving, via a first PDCCH candidate of the first set of PDCCH candidates, a first PDCCH transmission indicating puncturing information associated with a second PDCCH candidate of the second set of PDCCH candidates in accordance with the configuration; and monitoring the second PDCCH candidate for a second PDCCH transmission in accordance with the puncturing information.
Aspect 2: The method of Aspect 1, wherein the first PDCCH candidate is associated with at least one of a starting CCE that is aligned with a starting CCE for the second PDCCH candidate or an ending CCE that is aligned with an ending CCE for the second PDCCH candidate.
Aspect 3: The method of any of Aspects 1-2, wherein the configuration indicates a first quantity of PDCCH candidates of the first set of PDCCH candidates that is equal to a second quantity of PDCCH candidates of the second set of PDCCH candidates in accordance with a CORESET size associated with the first set of PDCCH candidates being the same as a CORESET size associated with the second set of PDCCH candidates.
Aspect 4: The method of any of Aspects 1-3, wherein the configuration indicates a size of the first search space that is larger than a size of the second search space, and indicates a quantity of PDCCH candidates of the first set of PDCCH candidates that is larger than a quantity of PDCCH candidates of the second set of PDCCH candidates.
Aspect 5: The method of any of Aspects 1-4, wherein the first PDCCH transmission indicates at least one of a starting CCE or an ending CCE for the second PDCCH candidate.
Aspect 6: The method of any of Aspects 1-5, wherein the configuration indicates a linking identifier associated with the first search space and the second search space.
Aspect 7: The method of any of Aspects 1-6, wherein the configuration indicates a puncturing mode for the first set of PDCCH candidates and the second set of PDCCH candidates.
Aspect 8: The method of any of Aspects 1-7, wherein the configuration indicates a puncturing state for the first set of PDCCH candidates, and wherein a value of the puncturing state indicates that the puncturing information associated with the second PDCCH candidate is to be transmitted via the first set of PDCCH candidates.
Aspect 9: The method of any of Aspects 1-8, wherein the configuration indicates a first index corresponding to the first search space and a second index corresponding to the second search space, and wherein the first index being lower than the second index indicates that the puncturing information associated with the second PDCCH candidate is to be transmitted via the first set of PDCCH candidates.
Aspect 10: The method of any of Aspects 1-9, wherein the first PDCCH transmission includes a first portion of a DCI message and the second PDCCH transmission includes a second portion of the DCI message.
Aspect 11: The method of Aspect 10, wherein a set of CCEs associated with the first set of PDCCH candidates is aligned with a set of CCEs associated with the second set of PDCCH candidates.
Aspect 12: The method of Aspect 11, wherein an AL associated with the first PDCCH candidate comprises an even value.
Aspect 13: The method of Aspect 10, wherein the configuration indicates one or more of a starting CCE or an ending CCE for each of the first set of PDCCH candidates and the second set of PDCCH candidates.
Aspect 14: The method of Aspect 10, further comprising: receiving an additional DCI message indicating one or more of a starting CCE or an ending CCE for each of the first PDCCH candidate and the second PDCCH candidate, wherein the additional DCI comprises a DCI format associated with configuring a split DCI transmission for the DCI message.
Aspect 15: The method of Aspect 10, wherein the configuration indicates a split-DCI mode for the first set of PDCCH candidates and the second set of PDCCH candidates.
Aspect 16: The method of any of Aspects 1-15, wherein a quantity of CCEs associated with the first set of PDCCH candidates and a quantity of CCEs associated with the second set of PDCCH candidates are each a power of two.
Aspect 17: The method of any of Aspects 1-16, wherein a quantity of PDCCH candidates associated with the first set of PDCCH candidates and a quantity of PDCCH candidates associated with the second set of PDCCH candidates are each a power of two.
Aspect 18: A method of wireless communication by a network node, comprising: transmitting a configuration for a MIMO PDCCH transmission indicating a first set of PDCCH candidates associated with a first search space and a second set of PDCCH candidates associated with a second search space; transmitting, via a first PDCCH candidate of the first set of PDCCH candidates, a first PDCCH transmission indicating puncturing information associated with a second PDCCH candidate of the second set of PDCCH candidates in accordance with the configuration; and transmitting, via the second PDCCH candidate, a second PDCCH transmission in accordance with the puncturing information.
Aspect 19: The method of Aspect 18, wherein the first PDCCH candidate is associated with at least one of a starting CCE that is aligned with a starting CCE for the second PDCCH candidate or an ending CCE that is aligned with an ending CCE for the second PDCCH candidate.
Aspect 20: The method of any of Aspects 18-19, wherein the configuration indicates a first quantity of PDCCH candidates of the first set of PDCCH candidates that is equal to a second quantity of PDCCH candidates of the second set of PDCCH candidates in accordance with a CORESET size associated with the first set of PDCCH candidates being the same as a CORESET size associated with the second set of PDCCH candidates.
Aspect 21: The method of any of Aspects 18-20, wherein the configuration indicates a size of the first search space that is larger than a size of the second search space, and indicates a quantity of PDCCH candidates of the first set of PDCCH candidates that is larger than a quantity of PDCCH candidates of the second set of PDCCH candidates.
Aspect 22: The method of any of Aspects 18-21, wherein the first PDCCH transmission indicates at least one of a starting CCE or an ending CCE for the second PDCCH candidate.
Aspect 23: The method of any of Aspects 18-22, wherein the configuration indicates a linking identifier associated with the first search space and the second search space.
Aspect 24: The method of any of Aspects 18-23, wherein the configuration indicates a puncturing mode for the first set of PDCCH candidates and the second set of PDCCH candidates.
Aspect 25: The method of any of Aspects 18-24, wherein the configuration indicates a puncturing state for the first set of PDCCH candidates, and wherein a value of the puncturing state indicates that the puncturing information associated with the second PDCCH candidate is to be transmitted via the first set of PDCCH candidates.
Aspect 26: The method of any of Aspects 18-25, wherein the configuration indicates a first index corresponding to the first search space and a second index corresponding to the second search space, and wherein the first index being lower than the second index indicates that the puncturing information associated with the second PDCCH candidate is to be transmitted via the first set of PDCCH candidates.
Aspect 27: The method of any of Aspects 18-26, wherein the first PDCCH transmission includes a first portion of a DCI message and the second PDCCH transmission includes a second portion of the DCI message.
Aspect 28: The method of Aspect 27, wherein a set of CCEs associated with the first set of PDCCH candidates is aligned with a set of CCEs associated with the second set of PDCCH candidates.
Aspect 29: The method of Aspect 28, wherein an AL associated with the first PDCCH candidate comprises an even value.
Aspect 30: The method of Aspect 27, wherein the configuration indicates one or more of a starting CCE or an ending CCE for each of the first set of PDCCH candidates and the second set of PDCCH candidates.
Aspect 31: The method of Aspect 27, further comprising: transmitting an additional DCI message indicating one or more of a starting CCE or an ending CCE for each of the first PDCCH candidate and the second PDCCH candidate, wherein the additional DCI comprises a DCI format associated with configuring a split DCI transmission for the DCI message.
Aspect 32: The method of Aspect 27, wherein the configuration indicates a split-DCI mode for the first set of PDCCH candidates and the second set of PDCCH candidates.
Aspect 33: The method of any of Aspects 18-32, wherein a quantity of CCEs associated with the first set of PDCCH candidates and a quantity of CCEs associated with the second set of PDCCH candidates are each a power of two.
Aspect 34: The method of any of Aspects 18-33, wherein a quantity of PDCCH candidates associated with the first set of PDCCH candidates and a quantity of PDCCH candidates associated with the second set of PDCCH candidates are each a power of two.
Aspect 35: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-34.
Aspect 36: An apparatus for wireless communication at a device, the apparatus comprising one or more memories and one or more processors coupled to the one or more memories, the one or more processors configured to cause the device to perform the method of one or more of Aspects 1-34.
Aspect 37: An apparatus for wireless communication, the apparatus comprising at least one means for performing the method of one or more of Aspects 1-34.
Aspect 38: A non-transitory computer-readable medium storing code for wireless communication, the code comprising instructions executable by one or more processors to perform the method of one or more of Aspects 1-34.
Aspect 39: A non-transitory computer-readable medium storing a set of instructions for wireless communication, the set of instructions comprising one or more instructions that, when executed by one or more processors of a device, cause the device to perform the method of one or more of Aspects 1-34.
Aspect 40: A device for wireless communication, the device comprising a processing system that includes one or more processors and one or more memories coupled with the one or more processors, the processing system configured to cause the device to perform the method of one or more of Aspects 1-34.
Aspect 41: An apparatus for wireless communication at a device, the apparatus comprising one or more memories and one or more processors coupled to the one or more memories, the one or more processors individually or collectively configured to cause the device to perform the method of one or more of Aspects 1-34.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

Further, as used herein, the phrase “based on” shall not be construed as a reference to a closed set of information, one or more conditions, or the like. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A UE for wireless communication, comprising:
a processing system that includes one or more processors and one or more memories coupled with the one or more processors, the processing system configured to cause the UE to:
receive a configuration for a multiple-input multiple-output (MIMO) physical downlink control channel (PDCCH) transmission indicating a first set of PDCCH candidates associated with a first search space and a second set of PDCCH candidates associated with a second search space;
receive, via a first PDCCH candidate of the first set of PDCCH candidates, a first PDCCH transmission indicating puncturing information associated with a second PDCCH candidate of the second set of PDCCH candidates in accordance with the configuration; and
monitor the second PDCCH candidate for a second PDCCH transmission in accordance with the puncturing information.

2. The UE of claim 1, wherein the first PDCCH candidate is associated with at least one of a starting control channel element (CCE) that is aligned with a starting CCE for the second PDCCH candidate or an ending CCE that is aligned with an ending CCE for the second PDCCH candidate.

3. The UE of claim 1, wherein the configuration indicates a first quantity of PDCCH candidates of the first set of PDCCH candidates that is equal to a second quantity of PDCCH candidates of the second set of PDCCH candidates in accordance with a control resource set size associated with the first set of PDCCH candidates being the same as a control resource set size associated with the second set of PDCCH candidates.

4. The UE of claim 1, wherein the configuration indicates a size of the first search space that is larger than a size of the second search space, and indicates a quantity of PDCCH candidates of the first set of PDCCH candidates that is larger than a quantity of PDCCH candidates of the second set of PDCCH candidates.

5. The UE of claim 1, wherein the first PDCCH transmission indicates at least one of a starting control channel element (CCE) or an ending CCE for the second PDCCH candidate.

6. The UE of claim 1, wherein the configuration indicates a linking identifier associated with the first search space and the second search space.

7. The UE of claim 1, wherein the configuration indicates a puncturing mode for the first set of PDCCH candidates and the second set of PDCCH candidates.

8. The UE of claim 1, wherein the configuration indicates a puncturing state for the first set of PDCCH candidates, and wherein a value of the puncturing state indicates that the puncturing information associated with the second PDCCH candidate is to be transmitted via the first set of PDCCH candidates.

9. The UE of claim 1, wherein the configuration indicates a first index corresponding to the first search space and a second index corresponding to the second search space, and wherein the first index being lower than the second index indicates that the puncturing information associated with the second PDCCH candidate is to be transmitted via the first set of PDCCH candidates.

10. The UE of claim 1, wherein the first PDCCH transmission includes a first portion of a downlink control information (DCI) message and the second PDCCH transmission includes a second portion of the DCI message.

11. The UE of claim 10, wherein a set of control channel elements (CCEs) associated with the first set of PDCCH candidates is aligned with a set of CCEs associated with the second set of PDCCH candidates.

12. The UE of claim 11, wherein an aggregation level associated with the first PDCCH candidate comprises an even value.

13. The UE of claim 10, wherein the configuration indicates one or more of a starting control channel element (CCE) or an ending CCE for each of the first set of PDCCH candidates and the second set of PDCCH candidates.

14. The UE of claim 10, wherein the processing system is further configured to cause the UE to:
receive an additional DCI message indicating one or more of a starting control channel element (CCE) or an ending CCE for each of the first PDCCH candidate and the second PDCCH candidate, wherein the additional DCI comprises a DCI format associated with configuring a split DCI transmission for the DCI message.

15. The UE of claim 10, wherein the configuration indicates a split-DCI mode for the first set of PDCCH candidates and the second set of PDCCH candidates.

16. The UE of claim 1, wherein a quantity of control channel elements (CCEs) associated with the first set of PDCCH candidates and a quantity of CCEs associated with the second set of PDCCH candidates are each a power of two.

17. The UE of claim 1, wherein a quantity of PDCCH candidates associated with the first set of PDCCH candidates and a quantity of PDCCH candidates associated with the second set of PDCCH candidates are each a power of two.

18. A network node for wireless communication, comprising:
a processing system that includes one or more processors and one or more memories coupled with the one or more processors, the processing system configured to cause the network node to:
transmit a configuration for a multiple-input multiple-output (MIMO) physical downlink control channel (PDCCH) transmission indicating a first set of PDCCH candidates associated with a first search space and a second set of PDCCH candidates associated with a second search space;
transmit, via a first PDCCH candidate of the first set of PDCCH candidates, a first PDCCH transmission indicating puncturing information associated with a second PDCCH candidate of the second set of PDCCH candidates in accordance with the configuration; and
transmit, via the second PDCCH candidate, a second PDCCH transmission in accordance with the puncturing information.

19. The network node of claim 18, wherein the first PDCCH candidate is associated with at least one of a starting control channel element (CCE) that is aligned with a starting CCE for the second PDCCH candidate or an ending CCE that is aligned with an ending CCE for the second PDCCH candidate.

20. The network node of claim 18, wherein the configuration indicates a first quantity of PDCCH candidates of the first set of PDCCH candidates that is equal to a second quantity of PDCCH candidates of the second set of PDCCH candidates in accordance with a control resource set size associated with the first set of PDCCH candidates being the same as a control resource set size associated with the second set of PDCCH candidates.

21. The network node of claim 18, wherein the configuration indicates a size of the first search space that is larger than a size of the second search space, and indicates a quantity of PDCCH candidates of the first set of PDCCH candidates that is larger than a quantity of PDCCH candidates of the second set of PDCCH candidates.

22. The network node of claim 18, wherein the first PDCCH transmission indicates at least one of a starting control channel element (CCE) or an ending CCE for the second PDCCH candidate.

23. The network node of claim 18, wherein the configuration indicates a linking identifier associated with the first search space and the second search space.

24. The network node of claim 18, wherein the configuration indicates a puncturing mode for the first set of PDCCH candidates and the second set of PDCCH candidates.

25. The network node of claim 18, wherein the configuration indicates a puncturing state for the first set of PDCCH candidates, and wherein a value of the puncturing state indicates that the puncturing information associated with the second PDCCH candidate is to be transmitted via the first set of PDCCH candidates.

26. The network node of claim 18, wherein the configuration indicates a first index corresponding to the first search space and a second index corresponding to the second search space, and wherein the first index being lower than the second index indicates that the puncturing information associated with the second PDCCH candidate is to be transmitted via the first set of PDCCH candidates.

27. The network node of claim 18, wherein the first PDCCH transmission includes a first portion of a downlink control information (DCI) message and the second PDCCH transmission includes a second portion of the DCI message.

28. The network node of claim 27, wherein a set of control channel elements (CCEs) associated with the first set of PDCCH candidates is aligned with a set of CCEs associated with the second set of PDCCH candidates.

29. A method for wireless communication by a user equipment (UE), comprising:
receiving a configuration for a multiple-input multiple-output (MIMO) physical downlink control channel (PDCCH) transmission indicating a first set of PDCCH candidates associated with a first search space and a second set of PDCCH candidates associated with a second search space;
receiving, via a first PDCCH candidate of the first set of PDCCH candidates, a first PDCCH transmission indicating puncturing information associated with a second PDCCH candidate of the second set of PDCCH candidates in accordance with the configuration; and
monitoring the second PDCCH candidate for a second PDCCH transmission in accordance with the puncturing information.

30. A method for wireless communication by a network node, comprising:
transmitting a configuration for a multiple-input multiple-output (MIMO) physical downlink control channel (PDCCH) transmission indicating a first set of PDCCH candidates associated with a first search space and a second set of PDCCH candidates associated with a second search space;
transmitting, via a first PDCCH candidate of the first set of PDCCH candidates, a first PDCCH transmission indicating puncturing information associated with a second PDCCH candidate of the second set of PDCCH candidates in accordance with the configuration; and
transmitting, via the second PDCCH candidate, a second PDCCH transmission in accordance with the puncturing information.
